(19) United States
(12) Patent Application Publication
(10) Pub. No.: US 2022/0245605 A1
(43) Pub. Date: Aug. 4, 2022

(54) METHODS, SYSTEMS, APPARATUSES, AND DEVICES FOR FACILITATING USERS TO PLAY LOTTERIES FOR PAYING OFF DEBTS OF THE USERS

(71) Applicant: Victor Olayinka Olaogun, ATLANTA, GA (US)

(72) Inventor: Victor Olayinka Olaogun, ATLANTA, GA (US)

(21) Appl. No.: 17/727,426

(22) Filed: Apr. 22, 2022

Related U.S. Application Data
(63) Continuation-in-part of application No. 17/159,033, filed on Jan. 26, 2021.
Application No. 17/159,033 is a continuation of application No. 16/924,652, filed on Jul. 9, 2020, now abandoned.
(60) Provisional application No. 62/872,041, filed on Jul. 9, 2019.

(51) Int. Cl. G06Q 20/10; G07F 17/32; G06Q 20/02

(52) U.S. Cl. CPC G06Q 20/102; G06Q 20/02; G07F 17/3244; G07F 17/329

(57) ABSTRACT

Disclosed herein is a device for facilitating users to play lotteries for paying off debts of the users, in accordance with some embodiments. Accordingly, the device comprises an input device, a storage device, an output device, and a processing device. The input device receives requests, receives an indication for purchasing tickets of virtual lotteries, and receives user data. The processing device processes a transaction for purchasing the tickets, tracks a current number of purchased tickets, randomly selects a winning ticket from the tickets, identifies a winner from the users using a ticket identifier of the winning ticket, compares a personal debt type of the winner with a lottery debt type of a virtual lottery and a personal debt amount of the winner with a lottery debt tier of the virtual lottery, and financially transfers a winning amount of the virtual lottery to a debtor of the winner.

The current application is a continuation-in-part (CIP) application of a U.S. non-provisional application Ser. No. 17/159,033 filed on Jan. 26, 2021. The U.S. non-provisional application Ser. No. 17/159,033 is a continuation application of a U.S. non-provisional application Ser. No. 16/924,652 filed on Jul. 9, 2020. The U.S. non-provisional application Ser. No. 16/924,652 claims a priority to a U.S. provisional patent application Ser. No. 62/872,041 filed on Jul. 9, 2019.

### FIELD OF THE INVENTION

Generally, the present disclosure relates to the field of amusement devices. More specifically, the present disclosure relates to methods, systems, apparatuses, and devices for facilitating users to play lotteries for paying off debts of the users.

### BACKGROUND OF THE INVENTION

Household debt is on the rise in many countries, and this is because the standard of living is increasing faster than the accumulation of disposable income. People are also easily exposed to high-end products and services with advancements in technology and the popularity of social media. These people are therefore compelled by various factors to purchase these high-end products and services on credit. There are also necessary purchases and investments needed in a household such as a house, a car, an education, and so on. These expenses also cost a lot of money and further limit the accumulation of disposable income. Household debt has become an increasingly heavy burden on most families in many countries, leading many to default as a result of job loss, divorce, family death, health complications, and so on.

Therefore, there is a need for improved methods, systems, apparatuses, and devices for facilitating users to play lotteries for paying off debts of the users that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a device for facilitating users to play lotteries for paying off debts of the users, in accordance with some embodiments. Accordingly, the device may include at least one input device, a storage device, at least one output device, and a processing device. Further, the at least one input device may be configured for receiving a plurality of requests from a plurality of users. Further, the at least one input device may be configured for receiving an indication for purchasing a number of tickets of at least one of a plurality of virtual lotteries from each of the plurality of users. Further, the at least one input device may be configured for receiving user data associated with each of the plurality of users from each of the plurality of users. Further, the user data may include a user information and a debt profile of each of the plurality of users. Further, the debt profile may include a debtor information of a debtor of each of the plurality of users and a personal debt type and a personal debt amount of a debt of each of the plurality of users. Further, the storage device may be communicatively coupled with the at least one input device. Further, the storage device may be configured for retrieving at least one of a plurality of tickets available to each of the plurality of users for the plurality of virtual lotteries based on each of the plurality of requests. Further, each virtual lottery of the plurality of virtual lotteries may include a lottery debt type and a lottery debt tier. Further, each virtual lottery of the plurality of virtual lotteries may be provided with a threshold of purchased tickets. Further, the plurality of tickets may include a plurality of ticket identifiers. Further, the plurality of ticket identifiers may be unique. Further, the storage device may be configured for storing a number of ticket identifiers of the number of tickets of at least one of the plurality of virtual lotteries and the user data of each of the plurality of users assigned to the number of tickets of at least one of the plurality of virtual lotteries based on the assigning. Further, the at least one output device may be communicatively coupled with the storage device. Further, the at least one output device may be configured for displaying at least one of the plurality of tickets available to each of the plurality of users for the plurality of virtual lotteries to each of the plurality of users. Further, the processing device may be communicatively coupled with the storage device. Further, the processing device may be configured for processing a transaction for purchasing the number of tickets of at least one of the plurality of virtual lotteries by each of the plurality of users based on the indication and the user information. Further, the processing device may be configured for assigning the number of tickets of at least one of the plurality of virtual lotteries to each of the plurality of users based on the processing of the transaction. Further, the processing device may be configured for tracking a current number of purchased tickets of each virtual lottery of the plurality of virtual lotteries based on the transaction. Further, the processing device may be configured for comparing the current number of purchased tickets with the threshold of purchased tickets for each virtual lottery of the plurality of virtual lotteries. Further, the processing device may be configured for randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries. Further, the processing device may be configured for identifying a winner from the plurality of users using a ticket identifier of the winning ticket based on the randomly selecting of the winning ticket. Further, the winner may be assigned to the winning ticket. Further, the processing device may be configured for comparing the personal debt type of the winner with the lottery debt type of the virtual lottery and the personal debt amount of the winner with the lottery debt tier of the virtual lottery based on the identifying. Further, the processing device may be configured for financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

Further disclosed herein is a device for facilitating users to play lotteries for paying off debts of the users, in accordance with some embodiments. Accordingly, the device may include at least one input device, a storage device, at least one output device, and a processing device. Further, the at least one input device may be configured for receiving a plurality of requests from a plurality of users. Further, the at least one input device may be configured for receiving an indication for purchasing a number of tickets of at least one of a plurality of virtual lotteries from each of the plurality of users. Further, the at least one input device may be configured for receiving user data associated with each of the plurality of users from each of the plurality of users. Further, the user data may include a user information and a debt profile of each of the plurality of users. Further, the debt profile may include a debtor information of a debtor of each of the plurality of users and a personal debt type and a personal debt amount of a debt of each of the plurality of users. Further, the storage device may be communicatively coupled with the at least one input device. Further, the storage device may be configured for retrieving at least one of a plurality of tickets available to each of the plurality of users for the plurality of virtual lotteries from a distributed ledger based on each of the plurality of requests. Further, each virtual lottery of the plurality of virtual lotteries may include a lottery debt type and a lottery debt tier. Further, each virtual lottery of the plurality of virtual lotteries may be provided with a threshold of purchased tickets. Further, the plurality of tickets may include a plurality of ticket identifiers. Further, the plurality of ticket identifiers may be unique. Further, the storage device may be configured for storing a number of ticket identifiers of the number of tickets of at least one of the plurality of virtual lotteries and the user data of each of the plurality of users assigned to the number of tickets of at least one of the plurality of virtual lotteries to the distributed ledger based on the assigning. Further, the at least one output device may be communicatively coupled with the storage device. Further, the at least one output device may be configured for displaying at least one of the plurality of tickets available to each of the plurality of users for the plurality of virtual lotteries to each of the plurality of users. Further, the processing device may be communicatively coupled with the storage device. Further, the processing device may be configured for processing a transaction for purchasing the number of tickets of at least one of the plurality of virtual lotteries by each of the plurality of users based on the indication and the user information. Further, the processing device may be configured for assigning the number of tickets of at least one of the plurality of virtual lotteries to each of the plurality of users based on the processing of the transaction. Further, the processing device may be configured for tracking a current number of purchased tickets of each virtual lottery of the plurality of virtual lotteries based on the transaction. Further, the processing device may be configured for comparing the current number of purchased tickets with the threshold of purchased tickets for each virtual lottery of the plurality of virtual lotteries. Further, the processing device may be configured for randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries. Further, the processing device may be configured for identifying a winner from the plurality of users using a ticket identifier of the winning ticket based on the randomly selecting of the winning ticket. Further, the winner may be assigned to the winning ticket. Further, the processing device may be configured for comparing the personal debt type of the winner with the lottery debt type of the virtual lottery and the personal debt amount of the winner with the lottery debt tier of the virtual lottery based on the identifying. Further, the processing device may be configured for financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a diagram illustrating a system of the present invention.

FIG. 2 is a flowchart illustrating the overall process for a method of the present invention.

FIG. 3 is a flowchart illustrating a continuation of the flowchart in FIG. 1.

FIG. 4 is a flowchart illustrating the subprocess for determining an applicable portion and a remainder portion of a pot for a desired lottery.

FIG. 5 is a flowchart illustrating the subprocess for designating the applicable portion of the desired lottery as a winning amount for the desired lottery.

FIG. 6 is a flowchart illustrating the subprocess for reallocating a transferable portion of the applicable portion of the desired lottery into the pot of a lower-tiered lottery.

FIG. 7 is a flowchart illustrating the subprocess for distributing the transferrable portion into the pot of each lower-tiered lottery in accordance with a reallocation percentage.

FIG. 8 is a flowchart illustrating the subprocess for reallocating the transferable portion of the desired lottery into a pot of a cash lottery.

FIG. 9 is a flowchart illustrating the subprocess for financially transferring the remainder portion of the desired lottery to an administrator account.

FIG. 10 is a flowchart illustrating the subprocess for outputting a specific ticket number of a ticket of the desired lottery with a corresponding user PC device.

FIG. 11 is a flowchart illustrating the subprocess for financially transferring a full portion of the winning amount for the desired lottery to the debtor information of an arbitrary user account.

FIG. 12 is a flowchart illustrating the subprocess for executing an electronic transfer for the full portion from the administrator account to the debtor information.

FIG. 13 is a flowchart illustrating the subprocess for generating a payment note for the full portion.

FIG. 14 is a flowchart illustrating the subprocess for financially transferring the leftover portion of the wining amount for the desired lottery only if a debt owed amount is less than the winning amount.

FIG. 15 is a flowchart illustrating the subprocess for executing an electronic transfer for the partial portion from the administrator account to the debtor information.

FIG. 16 is a flowchart illustrating the subprocess for generating a payment note for the partial portion.

FIG. 17 is a flowchart illustrating the subprocess for compiling a first debt profile and a second debt profile into a single debt profile.

FIG. 18 is a flowchart illustrating the subprocess for randomly selecting a winner for at least one specific lottery if the current number of purchased tickets is greater than or equal to a threshold for the purchased tickets.

FIG. 19 is a flowchart illustrating the subprocess for executing a financial purchase of a ticket for the desired lottery between an arbitrary user account and a third-part account and outputting a purchase confirmation.

FIG. 20 is a block diagram of a device for facilitating users to play lotteries for paying off debts of the users, in accordance with some embodiments.

FIG. 21 is a block diagram of the device, in accordance with some embodiments.

FIG. 22 is a block diagram of the device, in accordance with some embodiments.

FIG. 23 is a block diagram of the device, in accordance with some embodiments.

FIG. 24 is a block diagram of the device, in accordance with some embodiments.

FIG. 25 is a block diagram of a system for facilitating users to play lotteries for paying off debts of the users, in accordance with some embodiments.

FIG. 26 is a block diagram of a device for facilitating users to play lotteries for paying off debts of the users, in accordance with some embodiments.

FIG. 27 is an illustration of an online platform consistent with various embodiments of the present disclosure.

FIG. 28 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems, methods, apparatuses, and devices for facilitating users to play lotteries for paying off debts of the users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating users to play lotteries for paying off debts of the users.

Further, the present disclosure describes a solution whereby individuals are able to pay off a significant portion of the debt by playing the lottery. Further, the present disclosure describes giving individuals a chance to be relieved of debt burdens. Further, the present disclosure describes directly paying off any debt of an individual through a corresponding creditor. Further, the present disclosure describes increasing the chances of paying off debts by grouping debts based on types of debt and amounts of debt. Further, the present disclosure describes allowing an individual to increase individual chances of winning by purchasing as many desired tickets for a specific lottery as desired. Further, the present disclosure describes allowing a user to better manage multiple debts simultaneously.

Further, the present disclosure describes a lottery game terminal used in paying off debt. Further, a main terminal (MT) of the lottery game terminal generates a plurality of user accounts and virtual lotteries which are managed by a gaming server (the server, remote server, etc.) or a distributed and decentralized network. Players (via their respective GUI devices (the PC devices)) and lottery agents/operators (via the mini terminals stationed at their retail outlet) are able to connect to the main terminal (MT) and purchase lottery tickets. The data is sent to the MT to process payment, and generate and issue ticket numbers and bar codes. The MT automatically sorts and categorizes the tickets by lottery tiers and debt tiers and transfers them to the server. Once the time to play the drawn game ends, the MT allocate funds into different pots (applicable and remainder portions), then commands the server to choose the jackpot and cash prize tickets randomly after different algorithm and thresholds. The winning tickets (the jackpot and cash prize tickets) are then spooled and transferred to the main terminal for further processing where the administrator will pay off the debt.

The lottery game terminal is an electronic device that has data processing capabilities that involve a large use of computational operations and is integrated with the game's software application (the software can be a centralized or decentralized application). Further, the lottery game terminal may be enabled with an application programming interface (API). Further, the API allows developers to create the game's software application for the lottery game terminal. The lottery game terminal is made up of the main terminal (referred to as MT) and mini terminals.

The main terminal is a centrally connected smart device to which the mini terminals stationed in multiple locations are connected to. Each mini terminal is limited in its capacity since it is restricted to transactions that occur at a particular retail outlet. A Player can also connect to the main terminal via the corresponding user GUI (graphical user interface) device.

The MT is interfaced with payment processing systems, a check printer, an administrator's system, and a gaming server (the server, remote server, etc.) where all data is stored and managed. It also has different modules including but not limited to, at least an administrator account, and operator accounts.

Players are able to play the lottery game using the following methods:
A. Online: players of the game are able to connect to the main terminal by using their GUI (graphical user interface) devices. The first step will be to set up a user account, wherein each user account includes at least one debt profile, and wherein the debt profile includes debtor information, a debt type, and a debt amount. Each time there is a winning ticket, the user account is notified through the account and via email or text message (depending on the player's preference of communication).
B. Mini-Terminal: the mini terminal is installed/stationed in retail outlets for use by operators, which is connected to the main terminal. Players of the lottery game provide the operator with the required debt profile. Once payment is made, the ticket(s) is printed (or sent to the player's email address) with the ticket number and a bar code. An operator is able to check for winning tickets using the bar code scanner attached to the mini terminal. The mini terminal also has an operator's administration module where all transactions are recorded. Operators are able to record and search for all transactions as it relates to sales, voided/canceled tickets, claims, and commission paid and due to the operator. Instant scratch off tickets for the lottery game is also recorded on the mini terminal.
C. Instant Scratch Off Ticket: this is different from A and B. The Administrator generates the ticket numbers and bar codes from the main terminal in batches and predetermines and selects the jackpot and cash prize winning tickets.

The batches of ticket/bar code numbers are then taken to where each ticket will be individually printed on rolls of scratch off papers with a latex covering. The batches of rolls of scratch off tickets are then distributed to multiple retail outlets for operators to sell to players. Operators will record the batches of tickets on the mini terminal. This allows for the main terminal to account for each ticket location, know where the jackpot and cash prize tickets are, and for proper record keeping of sales and claims, among other things.

When a player wins the jackpot prize, the person(s) will take the ticket to the retail outlet where the ticket was purchased. The operator will scan the bar code on the ticket, using the scanner attached to the mini terminal to confirm authenticity. The main terminal sends a notification to confirm or reject the ticket. Once it is confirmed, the operator will get further information from the player to process the payment.

For cash prizes, the operator pays the player instantly and reconciles it to ticket sales remittance with the assistance of the operator's admin module on the mini terminal. Players will also be able to play the instant scratch game online.

Key systems/modules interfaced/built to the Main Terminal:
Check printer: a physical check printer is connected to the main terminal which is managed by the administrator account on the MT to pay the payee.
Payment systems: the main terminal will be interfaced with multiple payment systems to enable players to choose their preferred method of payment.
Operator Account: This is a module where all transaction on each mini terminal is recorded individually.
An Administrator Account: the administrator can connect to the administrator account (a module on MT) via the administrator's PC device. The administrator account is used to manage, monitor, and maintain the functionalities and operations of the lottery game. Some of the functions include but are not limited to:
   Set draw game dates
   Choose the number of lottery debt types and determine lottery debt tiers to be played
   Set a threshold and instruct the server to randomly pick a winning ticket
   Ability to cancel/void tickets
   Ability to transfer funds into different pots
   Ability to process the winners from the payment note module and instruct the MT to print the checks
   Command the MT to generate ticket numbers and bar codes for both draw games and instant scratch off tickets.
   Ability to make an electronic and financial transfer
   Ability to print checks.
   Report Generation: all information from the 3 methods of playing the lottery game ticket is fed into the main terminal to give a full account of the lottery game transactions. Therefore, the administrator is able to conduct query searches to view and or print reports. Reports for sales, claims, winning tickets, sales by a method of play, location, retail outlet, ticket reconciliation, etc.

According to some aspects, a main terminal (MT) is disclosed. Further, the MT is built and programmed such that it is able to compute the following: (A) generating a plurality of user accounts on the main terminal, wherein each user account is associated with a corresponding user GUI device (PC devices), and wherein each user account includes at least one debt profile, and wherein the debt profile includes a debtor information, a personal debt type, and a personal debt amount, (B) generating a plurality of virtual lotteries on the main terminal, wherein each virtual lottery includes a lottery debt type and a lottery debt tier, (C) enabling each user account to navigate through the lottery debt type and the lottery debt tier of each virtual lottery with the corresponding user GUI device, (D) prompting each user account to purchase at least one ticket for at least one desired lottery with the corresponding user GUI device, wherein the desired lottery is from the plurality of virtual lotteries, and providing each virtual lottery with a threshold for purchased tickets, (E) relaying the ticket for the desired lottery from the corresponding user GUI device of at least one arbitrary user account to the MT, if the ticket for the desired lottery is purchased by the arbitrary user account, wherein the arbitrary user account is any account from the plurality of user accounts, and tracking a current number for purchased tickets for each virtual lottery on the MT, (F) transferring all purchased tickets and user accounts to the gaming server and or a distributed and decentralized network (both the gaming server and the distributed and decentralized network shall be referred to as a server), commanding the server to randomly select a winner for each virtual lottery by randomly selecting a winner for at least one specific lottery, if the current number of purchased tickets of the specific lottery is greater than or equal to the threshold for purchased tickets, wherein the specific lottery is from the plurality of virtual lotteries, (G) financially transferring a winning amount for the desired lottery to the debtor information of the arbitrary user account, if the arbitrary user account is the winner of the desired lottery, and if the debt type of the arbitrary user account matches the lottery debt type of the desired lottery, and if the debt amount of the arbitrary user account is within or less than the lottery debt tier of the desired lottery, (H) providing at least one administrator account, wherein the administrator account is associated with a corresponding administrator PC device, (I) retrieving a debt owed amount from the debtor information of the arbitrary user account, and (J) financially transferring a full portion of the winning amount for the desired lottery to the debtor information of the arbitrary user account during step (G), if the debt owed amount is greater than or equal to the winning amount for the desired lottery, wherein the financially transferring of the full portion of the winning amount comprises generating a payment note for the full portion, wherein a payer of the payment note is the administrator account, and wherein a payee of the payment note is the debtor information of the arbitrary user account and printing the payment note using a check printer, wherein the payment note is a physical check, wherein the physical check allows the transfer of the winning amount from the MT.

Further, according to some aspects, the method of paying off debt through a lottery game terminal comprises providing at least one administrator account on the MT, wherein the administrator account is associated with a corresponding administrator PC device, wherein the lottery game is managed, monitored, and maintained on the MT. a key function of the administrator account is, retrieving a payout fraction for the virtual lotteries with the administrator PC device, and applying the payout fraction to the pot of the desired lottery on the MT in order to divide the pot of the desired lottery into an applicable portion and a remainder portion.

Further, according to some aspects, the method of paying off debt through a lottery game terminal comprises designating the applicable portion of the desired lottery as the winning amount for the desired lottery, if the applicable portion of the desired lottery is less than or within the lottery debt tier of the desired lottery tier.

Further, according to some aspects, the method of paying off debt through a lottery game terminal comprises the MT commanding the server to divide the applicable portion of the desired lottery into a usable portion and a transferrable portion, if the applicable portion of the desired lottery is greater than the lottery debt tier of the desired lottery tier, designating the usable portion of the desired lottery as the winning amount for the desired lottery on the server, comparing the lottery debt tier of the virtual lottery amongst each other in order to identify at least one lower-tiered lottery from the plurality of virtual lotteries, wherein the lottery debt tier of the lower-tiered lottery is less than the lottery debt tier of the desired lottery, and reallocating the transferrable portion of the desired lottery into the pot of the lower-tiered lottery on the server.

Further, according to some aspects, the method of paying off debt through a lottery game terminal comprises providing the at least one lower-tiered lottery as a plurality of lower-tiered lotteries, circumstantially assessing a reallocation percentage for each lower-tiered lottery, and distributing the transferrable portion of the desired lottery into the pot of each lower-tiered lottery in accordance with the reallocation percentage.

Further, according to some aspects, the method of paying off debt through a lottery game terminal comprises dividing the applicable portion of the desired lottery into a usable portion and a transferrable portion on the MT, if the applicable portion of the desired lottery is greater than the lottery debt tier of the desired lottery tier, designating the usable portion of the desired lottery as the winning amount for the desired lottery on the server, managing at least one cash lottery, and reallocating the transferrable portion of the desired lottery into a pot of the cash lottery.

Further, according to some aspects, the method of paying off debt through a lottery game terminal comprises financially transferring the remainder portion of the desired lottery to the administrator account on the MT.

Further, according to some aspects, the method of paying off debt through a lottery game terminal comprises providing a plurality of purchased tickets generated on the MT, wherein the plurality of purchased tickets includes the ticket for the desired lottery, cataloging each purchased ticket by assigning a specific ticket number and bar code to each purchased ticket, outputting the specific ticket number and bar code of the ticket of the desired lottery with the corresponding user GUI device of the arbitrary user account, and transferring the plurality of purchased tickets to the server to be stored and managed.

Further, according to some aspects, the method of paying off debt through a lottery game terminal comprises executing an electronic transfer for the full portion from the administrator account to the debtor information of the arbitrary user account on the MT.

Further, according to some aspects, the method of paying off debt through a lottery game terminal comprises providing at least one administrator account, wherein the administrator account is associated with a corresponding administrator PC device, retrieving a debt owed amount from the debtor information of the arbitrary user account on the MT, financially transferring a partial portion of the winning amount for the desired lottery to the debtor information of the arbitrary user account during step (G), if the debt owed amount is less than the winning amount for the desired lottery, wherein the partial portion is equal to the debt owed amount, and financially transferring a leftover portion of the winning amount for the desired lottery to the administrator account during step (G), if the debt owed amount is less than the winning amount for the desired lottery, wherein the leftover portion is equal to a difference between the winning amount of the desired lottery and the partial portion.

Further, according to some aspects, the method of paying off debt through a lottery game terminal comprises executing an electronic transfer for the partial portion from the administrator account to the debtor information of the arbitrary user account on the MT.

Further, according to some aspects, the method of paying off debt through a lottery game terminal comprises generating a payment note for the partial portion, wherein a payer of the payment note is the administrator account, and wherein a payee of the payment note is the debtor information of the arbitrary user account.

Further, according to some aspects, the method of paying off debt through a lottery game terminal comprises providing the at least one debt profile as a plurality of debt profiles of a specific user account, wherein the specific user account is from the plurality of user accounts, prompting the specific user account to append a first debt profile into a second debt profile with the corresponding user GUI device, wherein the first debt profile and the second debt profile are from the plurality of debt profiles and compiling the first debt profile and the second debt profile into a single debt profile on the MT, if the first debt profile is selected to be appended into the second debt profile by the specific user account, and if the personal debt type of the first debt profile matches the personal debt profile of the second debt profile.

Further, according to some aspects, the method of paying off debt through a lottery game terminal comprises providing at least one third-party account, wherein the third-party account is associated with a corresponding terminal device (the mini terminal), prompting the third-party account to enter a lottery search query for the arbitrary user account with the corresponding mini terminal device before step (D), relaying the lottery search query from the mini terminal device to the MT, if the lottery search query is entered by the third-party account, comparing the lottery search query to each virtual lottery on the MT in order to identify the desired lottery from the plurality of virtual lotteries, executing a financial purchase of the ticket for the desired lottery between the arbitrary user account and the third-party account through the MT after step (D), relaying a purchase confirmation of the ticket from the mini terminal device to the user GUI device, and outputting the purchase confirmation of the ticket with the user GUI device or by printing the ticket from the printer attached to the mini terminal.

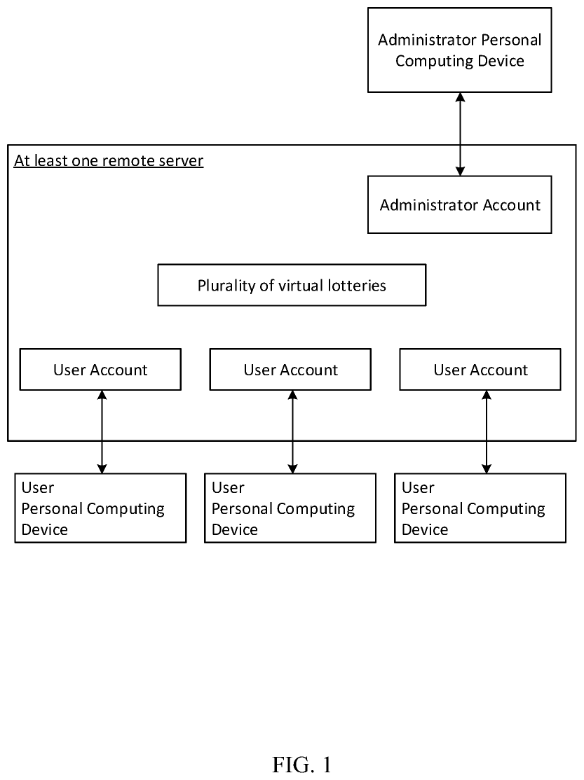

With reference to FIGS. 1-19, a system and method of paying off debt through a lottery. Thus, the physical system used to implement the method for the present invention includes at least one remote server (server, game server, etc.) and a corresponding user personal computing (PC) device. A plurality of user accounts is managed by the at least one remote server, wherein each user account is associated with a corresponding user PC device (Step A), as seen in FIG. 1. Any data associated with the plurality of user accounts are stored on the at least one remote server. More specifically, each user account includes at least one debt profile, and the debt profile includes a debtor information, a personal debt type, and a personal debt amount. The debt profile is any amount of money due to a creditor, such as a bank, a lessor, an educational institution, a credit card company, a car finance company, a hospital, and so on. The debtor information provides identification information of a debtor and any account information that is designated to receive payments. Moreover, a debtor can be, but is not limited to, an individual, a couple of company partners, or a corporate entity. The personal debt type specifies the type of debt owed to the creditor. The types of debt can be, but are not limited to, a loan, a balance, a medical bill, or a utility bill. The personal debt amount is the total amount of money owed by the debtor. A user PC device is preferably a smartphone. However, a user PC device can alternatively be, but is not limited to, a laptop, a tablet, a smartwatch, or a desktop. Furthermore, a plurality of virtual lotteries is provided and is managed by the remote server (Step B). The plurality of virtual lotteries provides a chance for each user account to pay off a personal debt amount. In order to provide equal chances of winning the virtual lottery, each virtual lottery includes a lottery debt type, such as a credit card debt, a car loan debt, a student loan debt, and a mortgage loan debt, and a lottery debt tier, which is a range of debt amounts wherein each personal debt amount falls within a lottery debt tier.

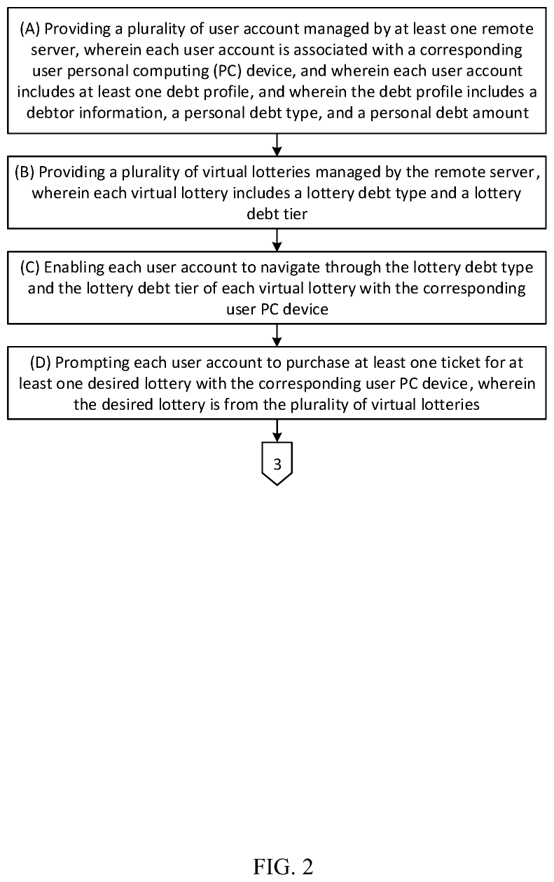

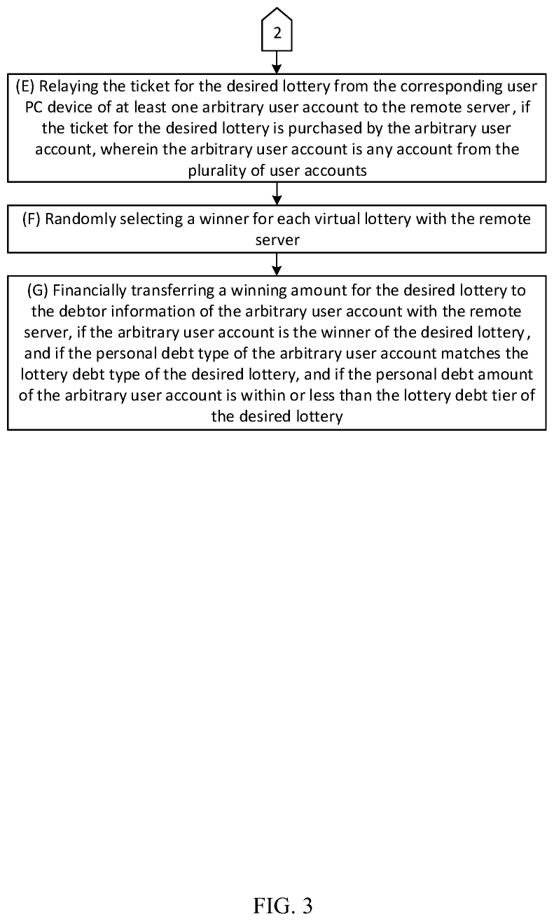

An overall process for the method of the present invention includes the following steps that are implemented with the at least one remote server and the plurality of user PC devices. As seen in FIG. 2, the overall process begins by enabling each user to navigate through the lottery debt type and the lottery debt tier of each virtual lottery with the corresponding PC device (Step C). This allows the user account to look through a catalog of available virtual lotteries that correspond with at least one personal debt amount. In order to be considered as part of a virtual lottery, each user account is prompted to purchase at least one ticket for at least one desired lottery with the corresponding user PC device (Step D). More specifically, the desired lottery is from the plurality of virtual lotteries such that the desired lottery corresponds with at least one debt profile. The ticket for the desired lottery is then relayed from the corresponding user PC device of at least one arbitrary account to the remote server if the ticket for the desired lottery is purchased by the arbitrary user account (Step E), as seen in FIG. 3. The arbitrary user account is any account from the plurality of user accounts. This associates the ticket with a user account and the corresponding debt profile of the user account. A debt of the arbitrary user account is therefore paid off or partially paid off for the user account as a winner is randomly selected for each virtual lottery with the remote server (Step F). A winning amount for the desired lottery is financially transferred to the debtor information of the arbitrary user account with the remote server in accordance with certain conditions (Step G), thereby paying off a portion if not all of the personal debt amount of the corresponding debt profile and the arbitrary user account no longer needs to pay off or pay a significant amount of the corresponding debt profile. Moreover, the winning amount is only transferred to the debtor information of the arbitrary user account, if the arbitrary user account is the winner of the desired lottery if the personal debt type of the arbitrary user account matches the lottery debt type of the desired lottery, and if the personal debt amount of the arbitrary user account is within or less than the lottery debt tier of the desired lottery. The virtual lottery therefore only accounts for the debt amount for a debt profile and does not provide additional money for the user account to spend as desired. Furthermore, if the debt type is that of a rental property and the creditor is a lessor, the lessor preferably requires a verification of employment, proof of income, or a verifiable secondary lessee prior to lease approval for the user account in order for the winning amount to be applied to the debt amount. The lessee also does not have to currently owe the lessor for a given duration of time in order to purchase a ticket in a lottery tier to win the stipulated number of months for an allowable lease. In the preferred embodiment of the present invention, a payment-processor account manages the financial transfer of the winning amount to the debtor information. The payment-processor account may electronically manage the financial transfer or prompt a check to be printed and then delivered to an address associated with the debtor information for the user account.

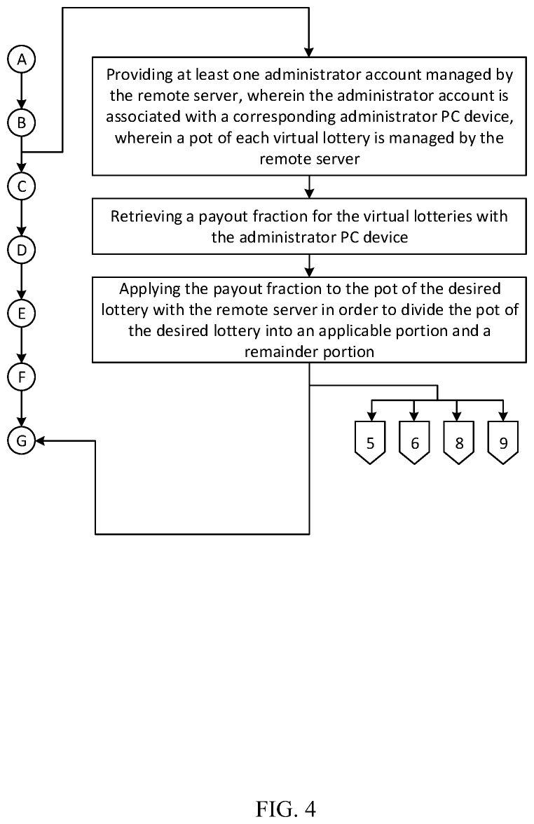

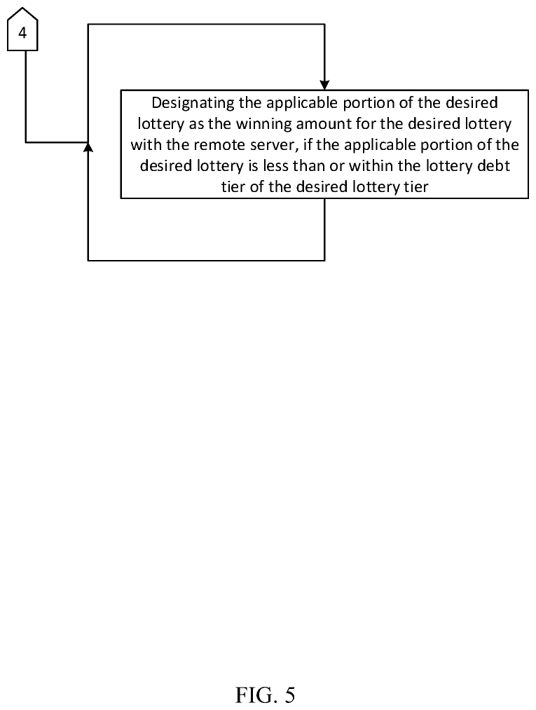

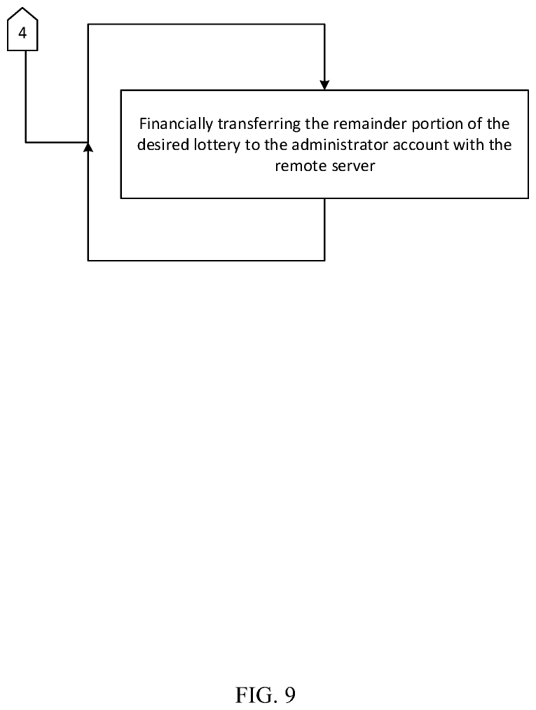

In order to manage the plurality of virtual lotteries and any investors that provide financial compensation for the winning amount of each virtual lottery, at least one administrator account that is managed by the remote server is provided, as seen in FIG. 4. The administrator account can be, but is not limited to, a lottery supplier, a designated operator of a government agency, or a government agency in charge of lottery and games that distributes the winning amount for each virtual lottery. More specifically, the administrator account is associated with a corresponding administrator PC device. A pot of each virtual lottery is managed by the remote server and the total monetary value of the purchased tickets. In order for the administrator account to maintain a revenue with the total amount of tickets purchased for each virtual lottery, a payout fraction for the virtual lotteries is retrieved with the administrator PC device. The payout fraction is applied to the pot of the desired lottery with the remote server in order to divide the pot of the desired lottery into an applicable portion and a remainder portion. The applicable portion is the percentage of the pot that pays off the debt amount of a corresponding debt profile for the user account. The remainder portion is the revenue gain for the administrator account. In order for the user account to receive the applicable portion, the applicable portion of the desired lottery is designated as the winning amount for the desired lottery with the remote server, if the applicable portion of the desired lottery is less than or within the lottery debt tier of the desired lottery tier, as seen in FIG. 5. The administrator account receives any revenue gain as the remainder portion of the desired lottery is financially transferred to the administrator account with the remote server, as seen in FIG. 9.

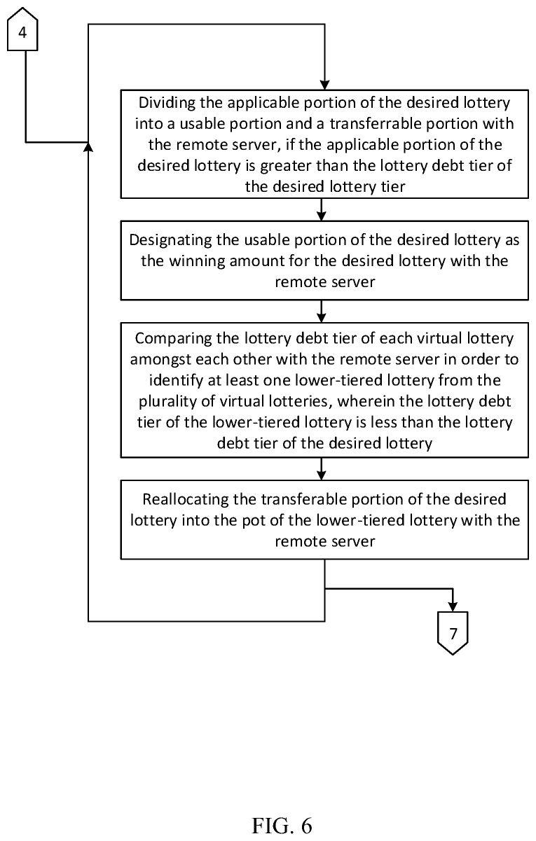

For some virtual lotteries, it may be the case that a large amount of tickets is purchased for a specific lottery type and lottery tier that the applicable portion exceeds that of the lottery debt tier. As seen in FIG. 6, the applicable portion of the desired lottery is then divided into a usable portion and a transferrable portion with the remote server, if the applicable portion of the desired lottery is greater than the lottery debt tier of the desired lottery tier. The debt amount of the corresponding debt profile for the winner is paid off as the usable portion of the desired lottery is designated as the winning amount for the desired lottery with the remote server. The transferrable portion is distributed accordingly as the lottery debt tier of each virtual lottery is compared amongst each other with the remote server in order to identify at least one lower-tiered from the plurality of virtual lotteries, wherein the lottery debt tier of the lower-tiered lottery is less than the lottery debt tier of the desired lottery. The transferrable portion of the desired lottery is then reallocated into the pot of the lower-tiered lottery with the remote server in order to for the pot of each lower-tiered lottery tier to fulfill the usable portion and completely pay off the debt amount.

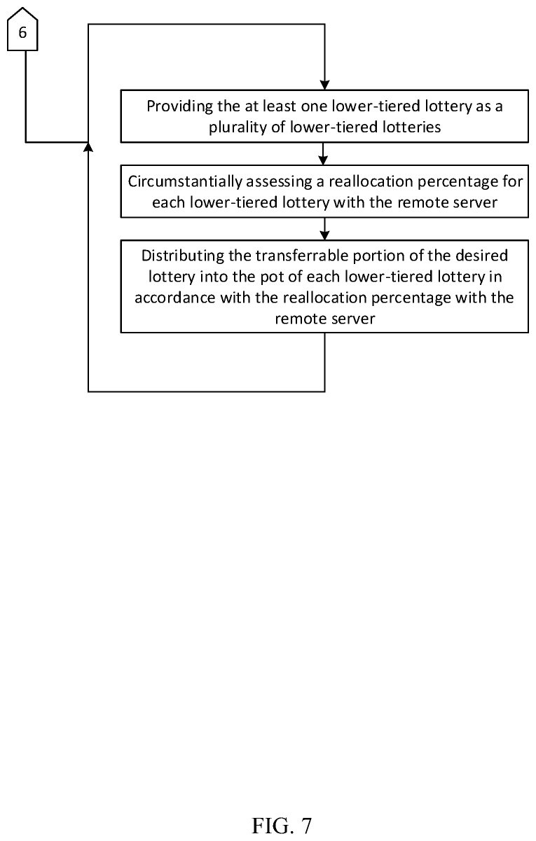

Furthermore, the at least one lower-tiered lottery is provided as a plurality of lower-tiered lotteries if multiple virtual lotteries have a lottery debt tier that is lower than that of the desired lottery tier of the desired lottery, as seen in FIG. 7. A reallocation percentage is circumstantially assessed for each lower-tiered lottery with the remote server. The reallocation percentage represents how much of the transferrable portion is given to each lower-tiered lottery and is preferably based on a variety of factors such as the monetary value of each lower-tiered lottery, the number of players in each lower-tiered lottery, the total average debt amount of the plurality of user accounts associated with each lower-tiered lottery, and so on. The transferrable portion of the desired lottery is then distributed into the pot of each lower-tiered lottery in accordance with the reallocation percentage with the remote server in order to prioritize among the lower-tiered lottery for a winner.

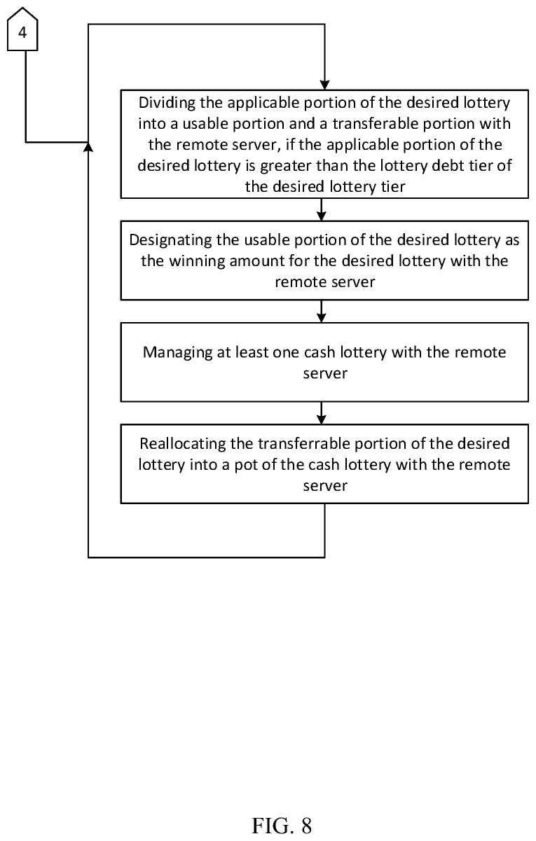

In an alternate embodiment of the present invention, the plurality of user accounts associated with a desired lottery that is not designated as the winner may receive a cash prize, as seen in FIG. 8. The applicable portion of the desired lottery is similarly divided into a usable portion and a transferrable portion with the remote server if the applicable portion of the desired lottery is greater than the lottery debt tier of the desired lottery tier. The usable portion of the desired lottery is designated as the winning amount for the desired lottery with the remote server. At least one cash lottery is managed with the remote server in order to select another winner for the cash prize among the remaining plurality of user accounts associated with the desired lottery. The transferrable portion of the desired lottery is reallocated into a pot of the cash lottery with the remote server, and the pot of the cash lottery preferably is smaller in value than that of the applicable portion.

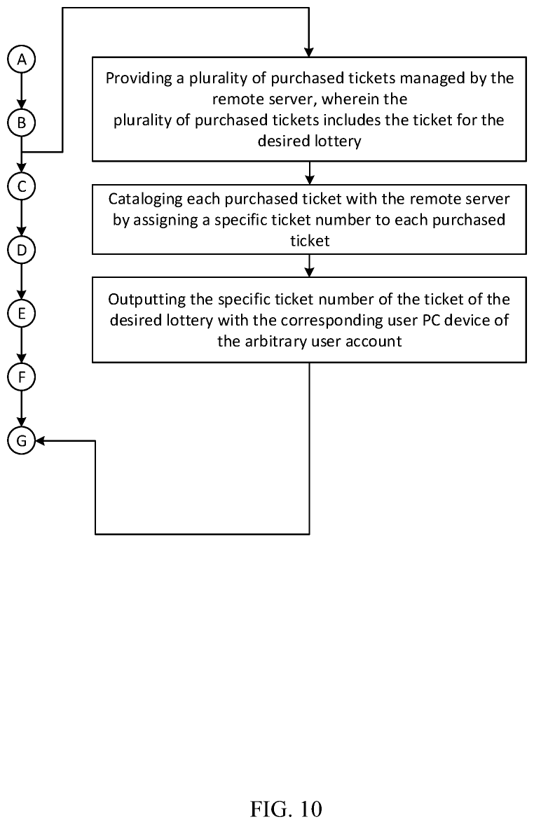

As user accounts purchase multiple tickets per debt type of each debt profile, a plurality of purchased tickets is provided and managed by the remote server, as seen in FIG. 10. The plurality of purchased tickets includes the ticket for the desired lottery, and each purchased ticket preferably includes a ticket identification number, a timestamp of purchase, drawing date information for the desired lottery, and so on. Each purchased ticket is cataloged with the remote server by assigning a specific ticket number to each purchased ticket, thereby associating and registering each ticket purchased for each debt profile. The specific ticket number differentiates each ticket purchased by a user account from any other tickets purchased by the same user account for the same desired lottery, as well as each ticket of other user accounts associated with the desired lottery. The specific ticket number of the ticket of the desired lottery is outputted with the corresponding user PC device of the arbitrary user account so that the user account can view and record the specific ticket number.

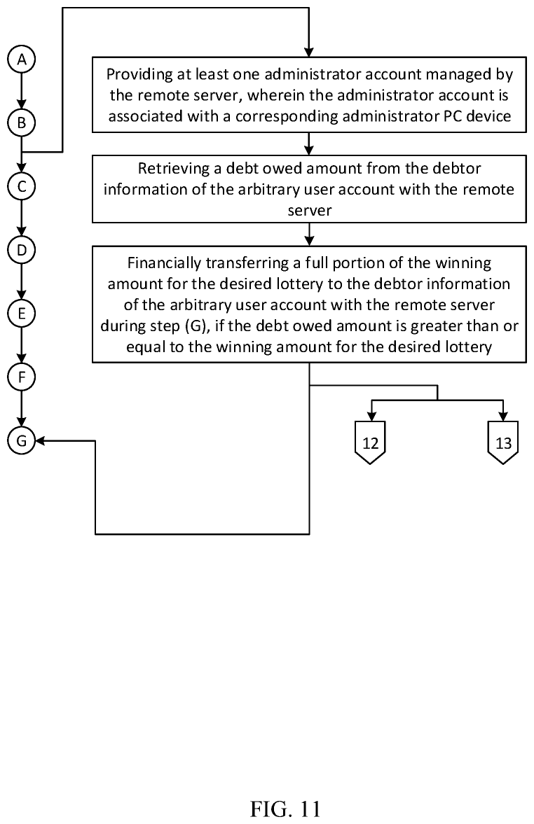

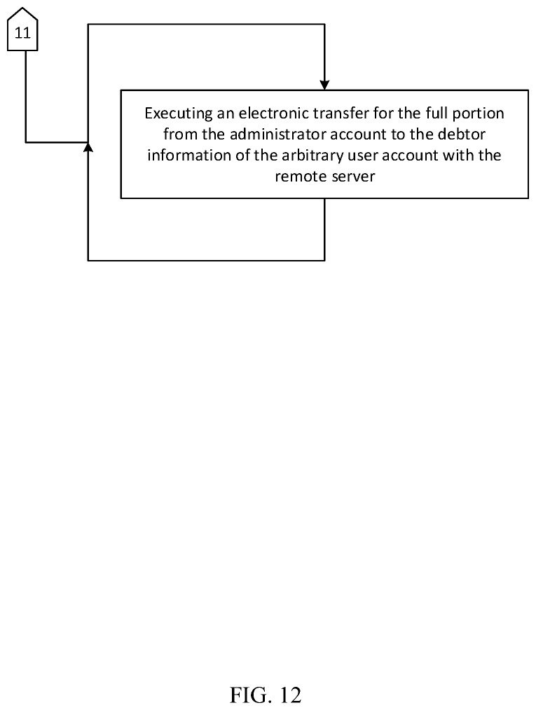

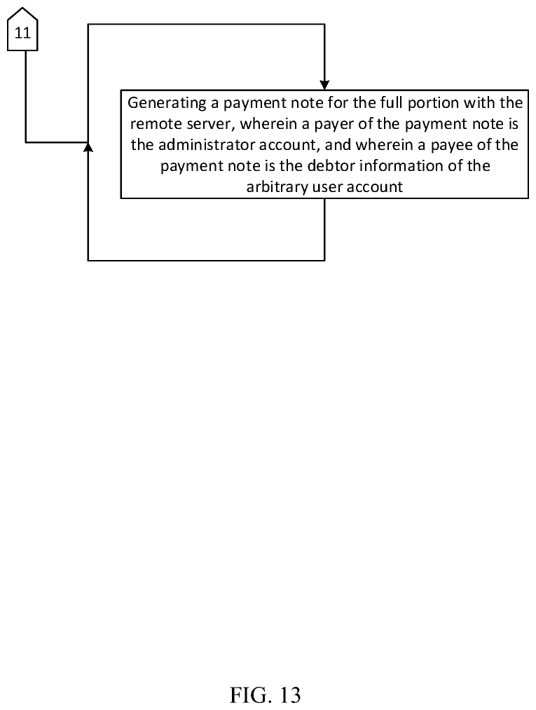

In order for the at least one administrator account to pay off the debt amount of the debt profile for the winner with the debtor information, a debt owed amount is retrieved from the debtor information of the arbitrary user account with the remote server, as seen in FIG. 11. This allows the at least one administrator to both verify the debt owed amount and compare the winning amount with the debt owed amount. A full portion of the winning amount for the desired lottery is then financially transferred to the debtor information of the arbitrary user account with the remote server during Step G, if the debt owed amount is greater than or equal to the winning amount for the desired lottery, thereby paying off a portion of the debt amount. The full portion accounts only for the winning amount such that the administrator account does not receive a remainder portion. An electronic transfer is executed for the full portion from the administrator account to the debtor information of the arbitrary user account with the remote server so that the administrator account may wirelessly transfer the winning amount to the debtor information, as seen in FIG. 12. Alternative to the electronic transfer, a payment note for the full portion is generated with the remote server, as seen in FIG. 13. The payment note is a physical check or comparable physical payment that serves as an alternative to the electronic transfer of the winning amount. The payment note is processed after the electronic transfer to serve as a receipt or confirmation for both the debtor information and the administrator account. More specifically, a payer of the payment note is the administrator account, and a payee of the payment note is the debtor information of the arbitrary user account. The payment note is processed and printed in order for the arbitrary user account to receive the payment note in the mail.

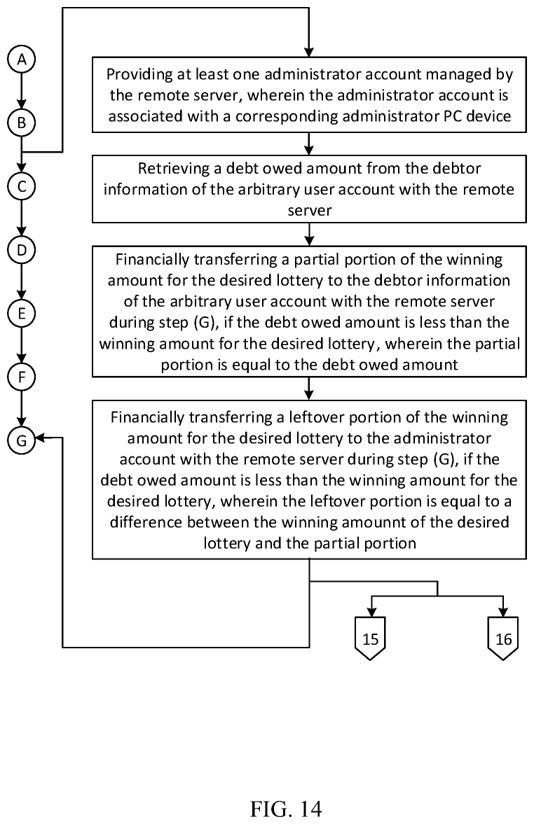

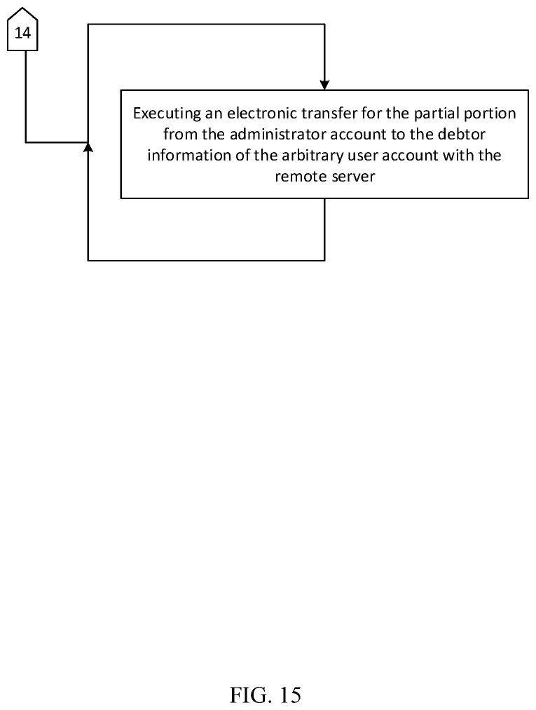

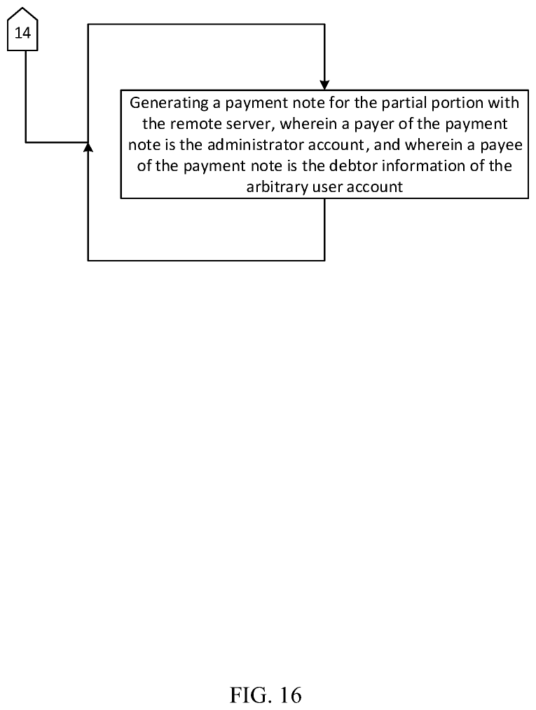

In the event that not enough tickets are not purchased for the virtual lottery, the administrator account pays off only a portion of the debt amount of the debt profile. As seen in FIG. 14, a partial portion of the winning amount for the desired lottery is financially transferred to the debtor information of the arbitrary user account with the remote server during Step G. The partial portion accounts for the entire debt amount as the debt owned amount is within the range of the lottery debt tier of the desired lottery. Moreover, the partial portion is only transferred if the debt owed amount is less than the winning amount for the desired lottery and, the partial portion is equal to the debt owed amount. A leftover portion of the winning amount for the desired lottery is financially transferred to the administrator account with the remote server during Step G if the debt owed amount is less than the winning amount for the desired lottery so that the administrator account is able to receive revenue gain with this financial transaction. Moreover, the leftover portion is equal to a difference between the winning amount of the desired lottery and the partial portion. An electronic transfer for the partial portion is executed from the administrator account to the debtor information of the arbitrary user account with the remote server so that the administrator account may wirelessly transfer funds to the debtor information, as seen in FIG. 15. A payment note for the partial portion is generated with the remote server, as seen in FIG. 16. The payment note is a physical check or comparable physical payment that serves as an alternative to the electronic transfer of the winning amount. The payment note is processed after the electronic transfer to serve as a receipt or confirmation for both the debtor information and the administrator account. Likewise, a payer of the payment note is the administrator account. A payee of the payment note is the debtor information of the arbitrary user account. The payment note is processed and printed in order for the arbitrary user account to receive the payment note in the mail.

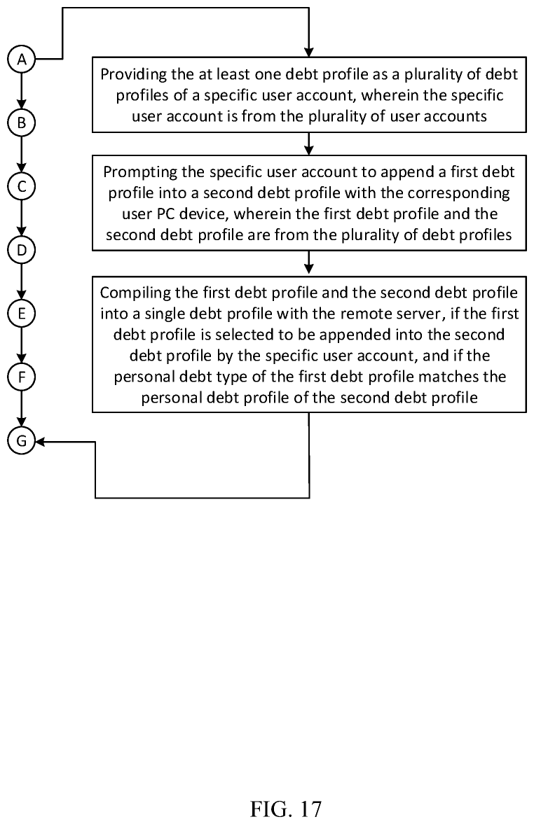

In order to facilitate the purchase of tickets of a desired lottery for the user account, the at least one debt profile is provided as a plurality of debt profiles of a specific user account, as seen in FIG. 17. More specifically, the specific user account is from the plurality of user accounts. The plurality of debt profiles may have different processing dates and varied debt amounts, but some of the debt profiles have the same debt type. The specific user account may facilitate the process of paying off multiple debt profiles with the same debt type as the specific user account is prompted to append a first debt profile into a second debt profile with the corresponding user PC device, wherein the first debt profile and the second debt profile are from the plurality of debt profiles. In order to consolidate the first debt profile and the second debt profile, the first debt profile and the second debt profile are compiled into a single debt profile with the remote server. This consolidation may only occur if the first debt profile is selected to be appended into the second debt profile by the specific user account and if the personal debt type of the first debt profile matches the personal debt profile of the second debt profile. The consolidation of the first debt profile and the second debt profile not only allows the specific user account to purchase less tickets in order to pay off the debt amount of the single debt profile but allows the specific user to purchase a ticket of high lottery debt tier than that of the first debt profile and that of the second debt profile.

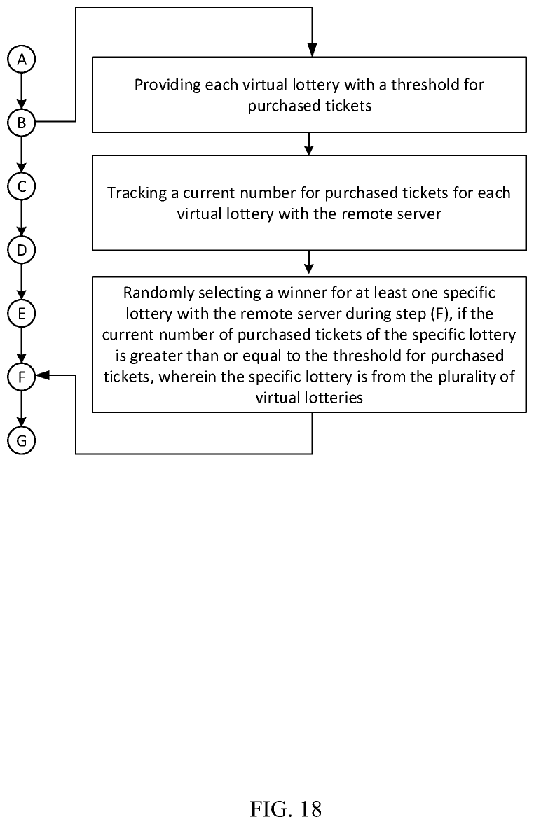

As each user account has options per debt type and debt tier, each virtual lottery must ensure a given amount of tickets purchased for each virtual lottery in order to be able to financially transfer the winning amount. Each virtual lottery is provided with a threshold for purchased tickets, which is a minimum amount of tickets purchased in order to proceed with a drawing for the virtual lottery, as seen in FIG. 18. A current number for purchased tickets for each virtual lottery is tracked with the remote server in order to be able to monitor the threshold for purchased tickets. A winner is then randomly selected for at least one specific lottery with the remote server during Step F, if the current number of purchased tickets of the specific lottery is greater than or equal to the threshold for the purchased tickets, wherein the specific lottery is from the plurality of virtual lotteries. A significant amount of the debt amount or the entire amount of the debt amount for the winner is guaranteed to be paid once the threshold for the purchased tickets is met.

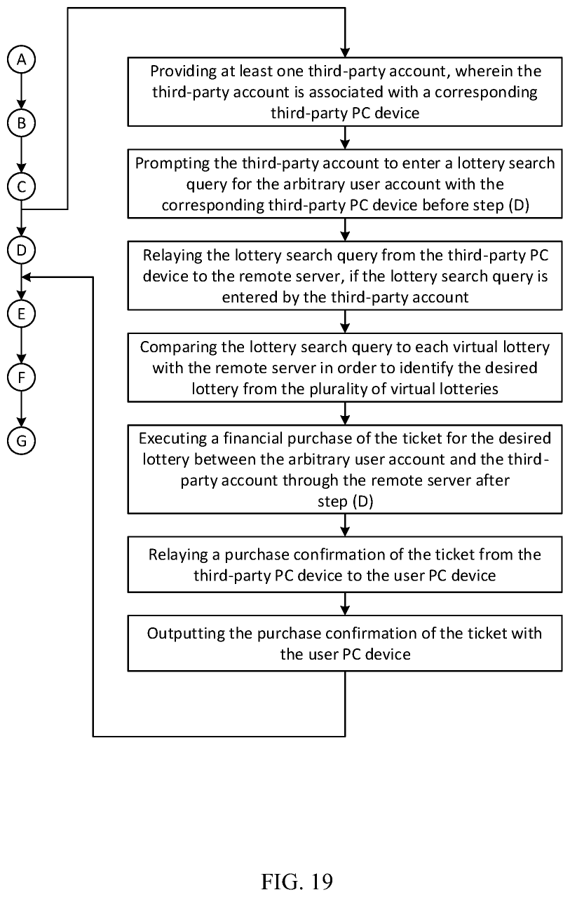

In order to aid the user account, at least one third-party account is provided, wherein the third-party account is associated with a corresponding third-party PC device, as seen in FIG. 19. Moreover, the third-party account is preferably used by a lottery retailer or lottery agent. The third-party account is prompted to enter a lottery search query for the arbitrary user account with the corresponding third-party PC device before Step D in order to provide the user account with a recommendation before a ticket is purchased by the user account. The lottery search query is relayed from the third-party PC device to the remote server if the lottery search query is entered by the third-party account. Subsequently, the lottery search query is compared to each virtual lottery with the remote server in order to identify the desired lottery from the plurality of virtual lotteries. The user account is able to remotely message the third-party account to view and analyze the recommendation of the third-party account. A financial purchase of the ticket for the desired lottery is then executed through the remote server after Step D. The financial purchase registers the user account with the desired lottery in order for the user account to be a possible winner. A purchase confirmation of the ticket from the third-party PC device is relayed to the user PC device, and the purchase confirmation of the ticket is outputted with the user PC device, so that the user account may view the purchase from the third-party account. The purchase confirmation of the ticket may then be printed with a printer for the physical records of the user account.

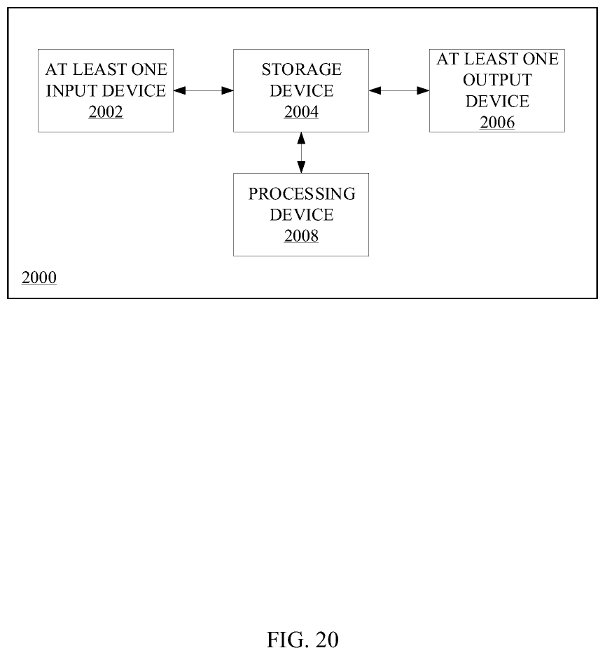

FIG. 20 is a block diagram of a device 2000 for facilitating users to play lotteries for paying off debts of the users, in accordance with some embodiments. Accordingly, the device 2000 may include at least one input device 2002, a storage device 2004, at least one output device 2006, and a processing device 2008. Further, the device 2000 may be a lottery game terminal, a main terminal, a mini terminal, a kiosk, a lottery game central processing device (LGCPD), etc. Further, the device 2000 may be enabled with an application programming interface (API). Further, the device 2000 may be an API enabled device.

Further, the at least one input device 2002 may be configured for receiving a plurality of requests from a plurality of users. Further, the plurality of users may include individuals, clients, etc. Further, the plurality of requests may be for playing the lotteries by the plurality of users. Further, the at least one input device 2002 may be configured for receiving an indication for purchasing a number of tickets of at least one of a plurality of virtual lotteries from each of the plurality of users. Further, the at least one input device 2002 may be configured for receiving user data associated with each of the plurality of users from each of the plurality of users. Further, the user data may include a user information and a debt profile of each of the plurality of users. Further, the user information may include a user's personal information, a user's financial information, a user's professional information, etc. Further, the debt profile may include a debtor information of a debtor of each of the plurality of users and a personal debt type and a personal debt amount of a debt of each of the plurality of users.

Further, the storage device 2004 may be communicatively coupled with the at least one input device 2002. Further, the storage device 2004 may be configured for retrieving at least one of a plurality of tickets available to each of the plurality of users for the plurality of virtual lotteries based on each of the plurality of requests. Further, each virtual lottery of the plurality of virtual lotteries may include a lottery debt type and a lottery debt tier. Further, each virtual lottery of the plurality of virtual lotteries may be provided with a threshold of purchased tickets. Further, the plurality of tickets may include a plurality of ticket identifiers. Further, the plurality of ticket identifiers may include a bar code, a QR code, an alphanumeric code, a RFID code, etc. Further, the plurality of ticket identifiers may be unique. Further, the storage device 2004 may be configured for storing a number of ticket identifiers of the number of tickets of at least one of the plurality of virtual lotteries and the user data of each of the plurality of users assigned to the number of tickets of at least one of the plurality of virtual lotteries based on the assigning.

Further, the at least one output device 2006 may be communicatively coupled with the storage device 2004. Further, the at least one output device 2006 may be configured for displaying at least one of the plurality of tickets available to each of the plurality of users for the plurality of virtual lotteries to each of the plurality of users.

Further, the processing device 2008 may be communicatively coupled with the storage device 2004. Further, the processing device 2008 may be configured for processing a transaction for purchasing the number of tickets of at least one of the plurality of virtual lotteries by each of the plurality of users based on the indication and the user information. Further, the processing device 2008 may be configured for assigning the number of tickets of at least one of the plurality of virtual lotteries to each of the plurality of users based on the processing of the transaction. Further, the processing device 2008 may be configured for tracking a current number of purchased tickets of each virtual lottery of the plurality of virtual lotteries based on the transaction. Further, the processing device 2008 may be configured for comparing the current number of purchased tickets with the threshold of purchased tickets for each virtual lottery of the plurality of virtual lotteries. Further, the processing device 2008 may be configured for determining whether the current number of purchased tickets is greater than the threshold of purchased tickets for each virtual lottery of the plurality of virtual lotteries. Further, the processing device 2008 may be configured for randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries. Further, the processing device 2008 may be configured for identifying a winner from the plurality of users using a ticket identifier of the winning ticket based on the randomly selecting of the winning ticket. Further, the winner may be assigned to the winning ticket. Further, the processing device 2008 may be configured for comparing the personal debt type of the winner with the lottery debt type of the virtual lottery and the personal debt amount of the winner with the lottery debt tier of the virtual lottery based on the identifying. Further, the processing device 2008 may be configured for financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

Further, in some embodiments, the storing of the number of ticket identifiers of the number of tickets of at least one of the plurality of virtual lotteries and the user data of each of the plurality of users assigned to the number of tickets of at least one of the plurality of virtual lotteries may include storing the number of ticket identifiers of the number of tickets of at least one of the plurality of virtual lotteries and the user data of each of the plurality of users assigned to the number of tickets of at least one of the plurality of virtual lotteries in a distributed ledger based on the assigning.

Further, in some embodiments, the retrieving of at least one of the plurality of tickets available to each of the plurality of users for the plurality of virtual lotteries may include retrieving at least one of the plurality of tickets available to each of the plurality of users for the plurality of virtual lotteries from a distributed ledger based on each of the plurality of requests.

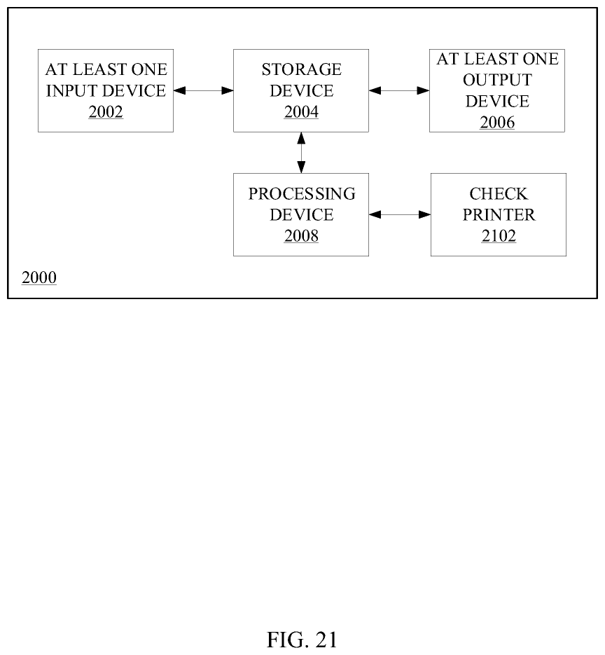

Further, in some embodiments, the financially transferring of the winning amount further may include generating a check of the winning amount for the debtor using the debtor information and the user information. Further, the processing device 2008 may be communicatively coupled with a check printer 2102, as shown in FIG. 21, comprised in the device 2000. Further, the check printer 2102 may include a daisy wheel printer, a laser printer, an inkjet printer, etc. Further, the check printer 2102 may be configured for printing a physical check of the check for the debtor based on the generating of the check.

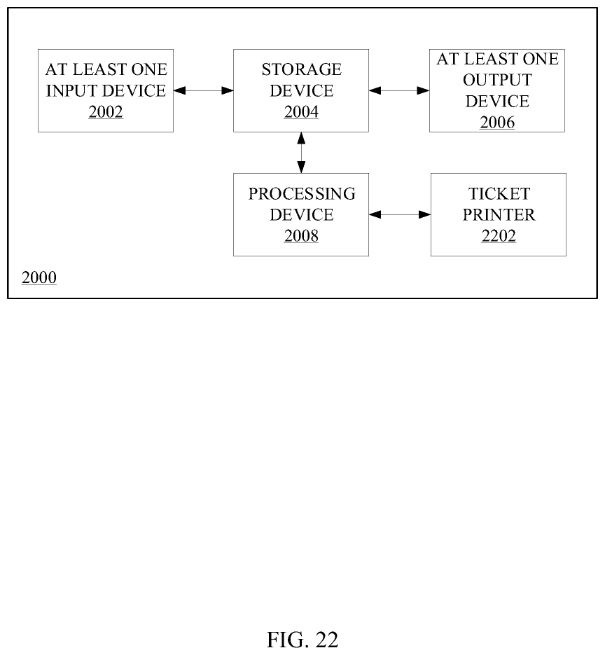

In further embodiments, the device 2000 may include a ticket printer 2202, as shown in FIG. 22. Further, the ticket printer 2202 may be communicatively coupled with the processing device 2008. Further, the ticket printer 2202 may include a daisy wheel printer, a laser printer, an inkjet printer, etc Further, the ticket printer 2202 may be configured for printing a number of physical tickets for the number of tickets based on the processing of the transaction. Further, the number of physical tickets may include a number of representations of the number of ticket identifiers. Further, the number of representations may include a visual representation, a haptic representation, etc. Further, the number of representations may be non-human readable.

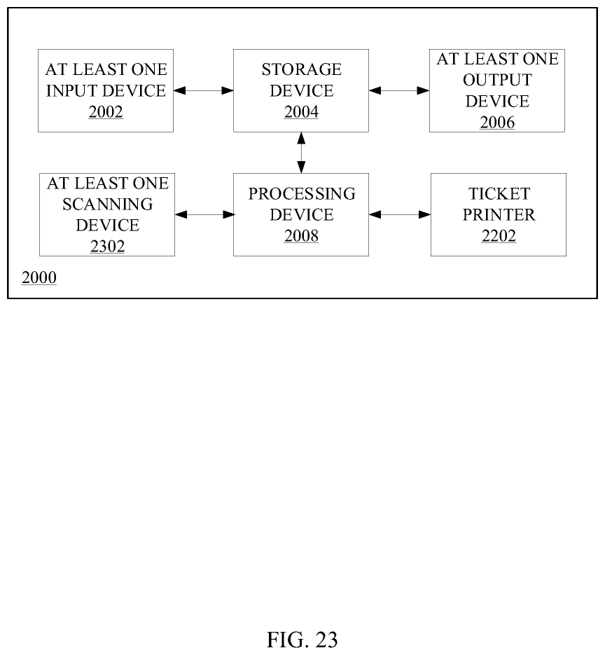

In further embodiments, the device 2000 may include at least one scanning device 2302, as shown in FIG. 23. Further, the at least one scanning device 2302 may include a bar code reader, a QR code reader, a scanner, a RFID code reader, etc. Further, the at least one scanning device 2302 may be comprised of at least one image sensor. Further, the at least one scanning device 2302 may be communicatively coupled with the processing device 2008. Further, the at least one scanning device 2302 may be configured for detecting a ticket identifier of a physical ticket based on scanning a representation of the ticket identifier. Further, the processing device 2008 may be configured for comparing the ticket identifier of the physical ticket with the ticket identifier of the winning ticket. Further, the processing device 2008 may be configured for determining the physical ticket as the winning ticket based on the comparing of the ticket identifier of the physical ticket with the ticket identifier of the winning ticket. Further, the financially transferring of the winning amount of the virtual lottery to the debtor of the winner may be further based on the determining.

Further, in some embodiments, the debtor information may include a mode of payment of the debt. Further, the mode of payment may include an electronic transfer, a wire transfer, a bank transfer, etc. Further, the financially transferring of the winning amount may include financially transferring the winning amount to the debtor through the mode of payment.

Further, in some embodiments, the processing device 2008 may be configured for generating a number of cryptocurrency tokens for the winning amount. Further, the number of cryptocurrency tokens may be associated with at least one cryptocurrency. Further, the generating of the number of cryptocurrency tokens may include minting the number of cryptocurrency tokens for the winning amount. Further, the financially transferring of the winning amount may include transferring the number of cryptocurrency tokens to the debtor.

Further, in some embodiments, the randomly selecting of the winning ticket from the number of tickets for the virtual lottery of the plurality of virtual lotteries may include randomly selecting the winning ticket for the virtual lottery of the plurality of virtual lotteries using at least one random ticket selection model based on the comparing of the current number of purchased tickets with the threshold of purchased tickets for each virtual lottery of the plurality of virtual lotteries. Further, the at least one random ticket selection model may be an artificial intelligence model for generating random numbers.

Further, in some embodiments, the processing device 2008 may be configured for analyzing the current number of tickets. Further, the processing device 2008 may be configured for determining a rate of purchasing of tickets of each virtual lottery of the plurality of virtual lotteries based on the analyzing. Further, the processing device 2008 may be configured for determining the threshold of purchased tickets for each virtual lottery of the plurality of virtual lotteries based on the determining of the rate of purchasing of tickets of each virtual lottery of the plurality of virtual lotteries.

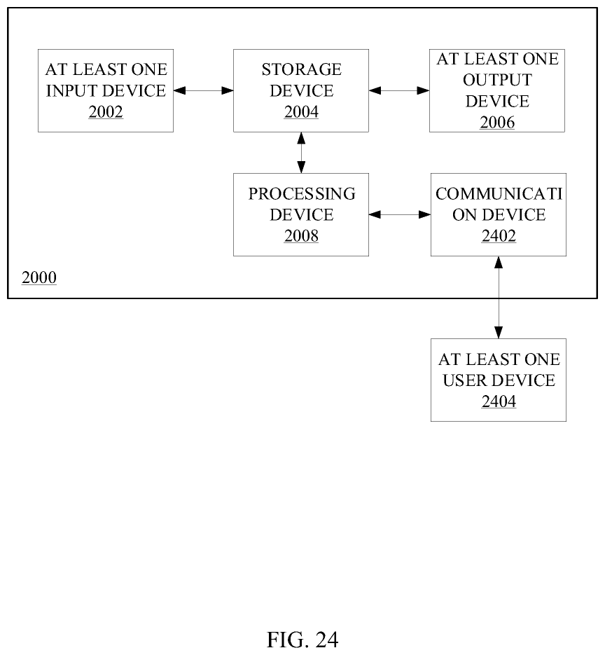

In further embodiments, the device 2000 may include a communication device 2402, as shown in FIG. 24. Further, the communication device 2402 may be communicatively coupled with the processing device 2008. Further, the communication device 2402 may be configured for receiving the threshold of purchased tickets for each virtual lottery of the plurality of virtual lotteries from at least one user device 2404, as shown in FIG. 24. Further, the at least one user device 2404 may include a computing device, a client device, etc. Further, the at least one user device 2404 may be associated with at least one operator of the device 2000.

Further, in some embodiments, each virtual lottery of the plurality of virtual lotteries may be provided with the threshold of purchased tickets corresponding to at least one of the lottery debt type and the lottery debt tier. Further, the processing device 2008 may be configured for categorizing the current number of purchased tickets of each virtual lottery of the plurality of virtual lotteries current into at least one of the lottery debt type and the lottery debt tier. Further, the comparing of the current number of purchased tickets with the threshold of purchased tickets for each virtual lottery of the plurality of virtual lotteries may include comparing the current number of purchased tickets with the threshold of purchased tickets corresponding to at least one of the lottery debt type and the lottery debt tier for each virtual lottery of the plurality of virtual lotteries based on the categorizing. Further, the randomly selecting of the winning ticket from the number of tickets for the virtual lottery of the plurality of virtual lotteries may include randomly selecting the winning ticket from the number of tickets for at least one of the lottery debt type and the lottery debt tier of the virtual lottery of the plurality of virtual lotteries.

FIG. 21 is a block diagram of the device 2000, in accordance with some embodiments.

FIG. 22 is a block diagram of the device 2000, in accordance with some embodiments.

FIG. 23 is a block diagram of the device 2000, in accordance with some embodiments.

FIG. 24 is a block diagram of the device 2000, in accordance with some embodiments.

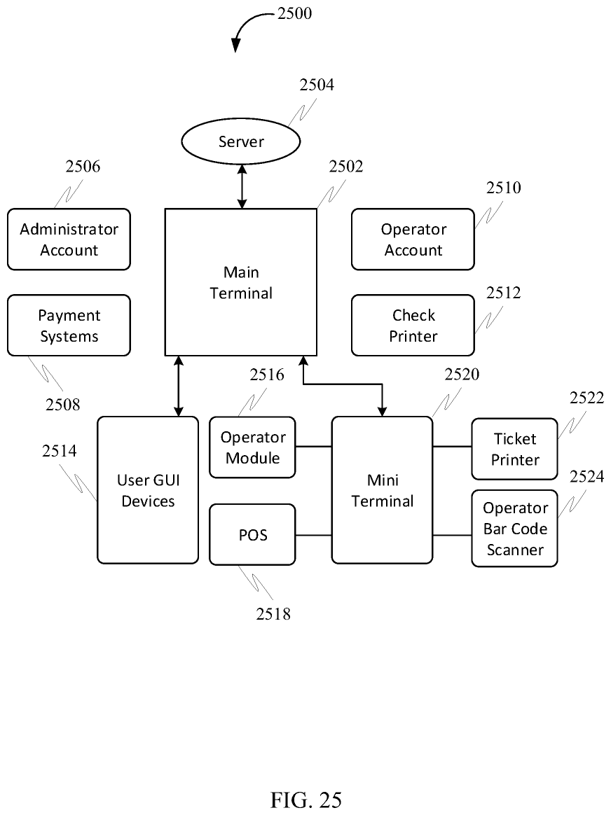

FIG. 25 is a block diagram of a system 2500 for facilitating users to play lotteries for paying off debts of the users, in accordance with some embodiments. Further, the system 2500 may include a main terminal (MT) 2502, a server 2504, user GUI devices 2514 (PC devices), and a mini terminal 2520. Further, the main terminal 2502 may be enabled with an application programming interface (API). Further, the main terminal 2502 may be communicatively coupled with the server 2504, the user GUI devices 2514, and the mini terminal 2520. Further, the main terminal 2502 may include an administrator account 2506, payment systems 2508, an operator account 2510, and a check printer 2512. Further, the mini terminal 2520 may include an operator module 2516, a POS 2518, a ticket printer 2522, and an operator bar code reader 2524.

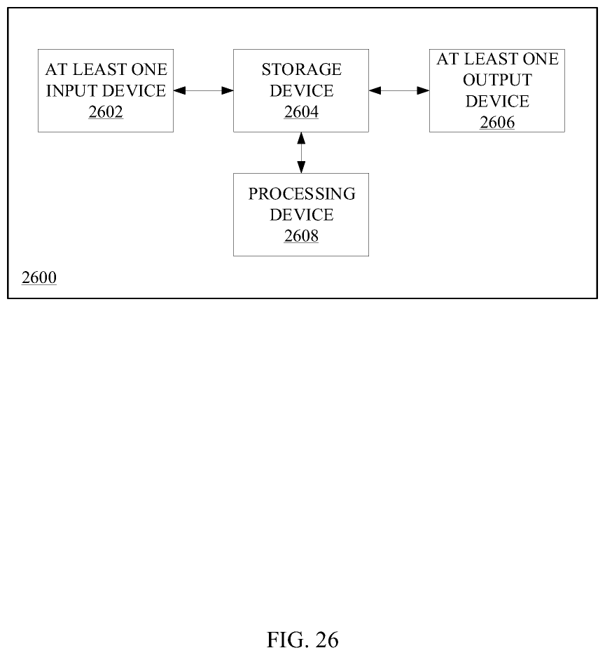

FIG. 26 is a block diagram of a device 2600 for facilitating users to play lotteries for paying off debts of the users, in accordance with some embodiments. Accordingly, the device 2600 may include at least one input device 2602, a storage device 2604, at least one output device 2606, and a processing device 2608. Further, the device 2600 may be enabled with an application programming interface (API). Further, the device 2600 may be an API enabled device.

Further, the at least one input device 2602 may be configured for receiving a plurality of requests from a plurality of users. Further, the at least one input device 2602 may be configured for receiving an indication for purchasing a number of tickets of at least one of a plurality of virtual lotteries from each of the plurality of users. Further, the at least one input device 2602 may be configured for receiving user data associated with each of the plurality of users from each of the plurality of users. Further, the user data may include a user information and a debt profile of each of the plurality of users. Further, the debt profile may include a debtor information of a debtor of each of the plurality of users and a personal debt type and a personal debt amount of a debt of each of the plurality of users.

Further, the storage device 2604 may be communicatively coupled with the at least one input device 2602. Further, the storage device 2604 may be configured for retrieving at least one of a plurality of tickets available to each of the plurality of users for the plurality of virtual lotteries from a distributed ledger based on each of the plurality of requests. Further, each virtual lottery of the plurality of virtual lotteries may include a lottery debt type and a lottery debt tier. Further, each virtual lottery of the plurality of virtual lotteries may be provided with a threshold of purchased tickets. Further, the plurality of tickets may include a plurality of ticket identifiers. Further, the plurality of ticket identifiers may be unique. Further, the storage device 2604 may be configured for storing a number of ticket identifiers of the number of tickets of at least one of the plurality of virtual lotteries and the user data of each of the plurality of users assigned to the number of tickets of at least one of the plurality of virtual lotteries to the distributed ledger based on the assigning.

Further, the at least one output device 2606 may be communicatively coupled with the storage device 2604. Further, the at least one output device 2606 may be configured for displaying at least one of the plurality of tickets available to each of the plurality of users for the plurality of virtual lotteries to each of the plurality of users.

Further, the processing device 2608 may be communicatively coupled with the storage device 2604. Further, the processing device 2608 may be configured for processing a transaction for purchasing the number of tickets of at least one of the plurality of virtual lotteries by each of the plurality of users based on the indication and the user information. Further, the processing device 2608 may be configured for assigning the number of tickets of at least one of the plurality of virtual lotteries to each of the plurality of users based on the processing of the transaction. Further, the processing device 2608 may be configured for tracking a current number of purchased tickets of each virtual lottery of the plurality of virtual lotteries based on the transaction. Further, the processing device 2608 may be configured for comparing the current number of purchased tickets with the threshold of purchased tickets for each virtual lottery of the plurality of virtual lotteries. Further, the processing device 2608 may be configured for randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries. Further, the processing device 2608 may be configured for identifying a winner from the plurality of users using a ticket identifier of the winning ticket based on the randomly selecting of the winning ticket. Further, the winner may be assigned to the winning ticket. Further, the processing device 2608 may be configured for comparing the personal debt type of the winner with the lottery debt type of the virtual lottery and the personal debt amount of the winner with the lottery debt tier of the virtual lottery based on the identifying. Further, the processing device 2608 may be configured for financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

Further, in some embodiments, the financially transferring of the winning amount further may include generating a check of the winning amount for the debtor using the debtor information and the user information. Further, the processing device 2608 may be communicatively coupled with a check printer comprised in the device. Further, the check printer may be configured for printing a physical check of the check for the debtor based on the generating of the check.

In further embodiments, the device 2600 may include a ticket printer. Further, the ticket printer may be communicatively coupled with the processing device 2608. Further, the ticket printer may be configured for printing a number of physical tickets for the number of tickets based on the processing of the transaction. Further, the number of physical tickets may include a number of representations of the number of ticket identifiers.

In further embodiments, the device 2600 may include at least one scanning device. Further, the at least one scanning device may be communicatively coupled with the processing device 2608. Further, the at least one scanning device may be configured for detecting a ticket identifier of a physical ticket based on scanning a representation of the ticket identifier. Further, the processing device 2608 may be configured for comparing the ticket identifier of the physical ticket with the ticket identifier of the winning ticket. Further, the processing device 2608 may be configured for determining the physical ticket as the winning ticket based on the comparing of the ticket identifier of the physical ticket with the ticket identifier of the winning ticket. Further, the financially transferring of the winning amount of the virtual lottery to the debtor of the winner may be further based on the determining.

Further, in some embodiments, the debtor information may include a mode of payment of the debt. Further, the financially transferring of the winning amount may include financially transferring the winning amount to the debtor through the mode of payment.

Further, in some embodiments, the processing device 2608 may be configured for generating a number of cryptocurrency tokens for the winning amount. Further, the generating of the number of cryptocurrency tokens may include minting the number of cryptocurrency tokens for the winning amount. Further, the financially transferring of the winning amount may include transferring the number of cryptocurrency tokens to the debtor.

Further, in some embodiments, the randomly selecting of the winning ticket from the number of tickets for the virtual lottery of the plurality of virtual lotteries may include randomly selecting the winning ticket for the virtual lottery of the plurality of virtual lotteries using at least one random ticket selection model based on the comparing of the current number of purchased tickets with the threshold of purchased tickets for each virtual lottery of the plurality of virtual lotteries.

Further, in some embodiments, the processing device 2608 may be configured for analyzing the current number of tickets. Further, the processing device 2608 may be configured for determining a rate of purchasing of tickets of each virtual lottery of the plurality of virtual lotteries based on the analyzing of the current number of tickets. Further, the processing device 2608 may be configured for determining the threshold of purchased tickets for each virtual lottery of the plurality of virtual lotteries based on the determining of the rate of purchasing of tickets of each virtual lottery of the plurality of virtual lotteries.

In further embodiments, the device 2600 may include a communication device. Further, the communication device may be communicatively coupled with the processing device 2608. Further, the communication device may be configured for receiving the threshold of purchased tickets for each virtual lottery of the plurality of virtual lotteries from at least one user device.

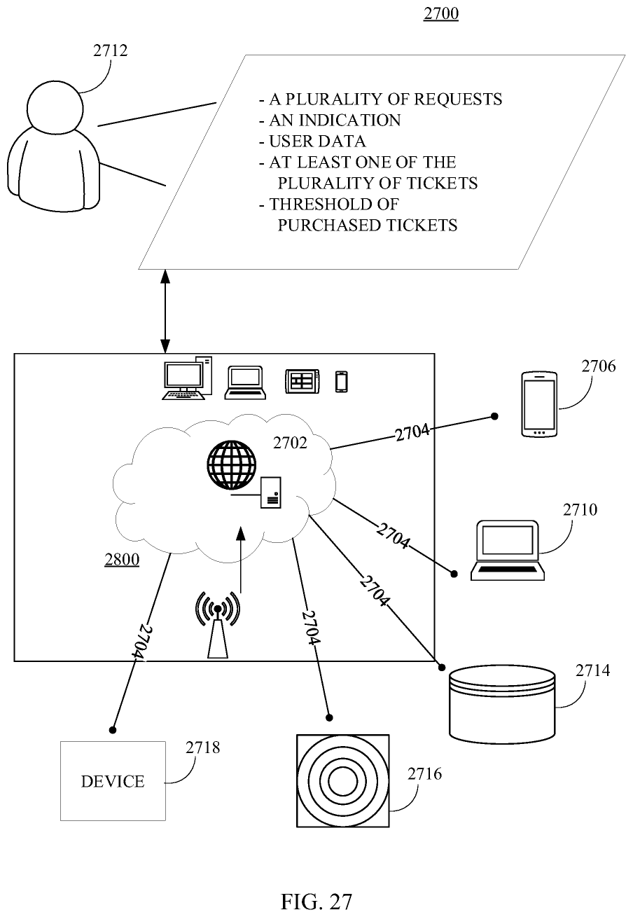

FIG. 27 is an illustration of an online platform 2700 consistent with various embodiments of the present disclosure. By way of non-limiting example, the online platform 2700 to facilitate users to play lotteries for paying off debts of the users may be hosted on a centralized server 2702, such as, for example, a cloud computing service. The centralized server 2702 may communicate with other network entities, such as, for example, a mobile device 2706 (such as a smartphone, a laptop, a tablet computer, etc.), other electronic devices 2710 (such as desktop computers, server computers, etc.), databases 2714, sensors 2716, and a device 2718 (such as the device 2000, the device 2600, etc.) over a communication network 2704, such as, but not limited to, the Internet. Further, users of the online platform 2700 may include relevant parties such as, but not limited to, end-users, administrators, service providers, service consumers, and so on. Accordingly, in some instances, electronic devices operated by the one or more relevant parties may be in communication with the platform.

A user 2712, such as the one or more relevant parties, may access online platform 2700 through a web based software application or browser. The web based software application may be embodied as, for example, but not be limited to, a website, a web application, a desktop application, and a mobile application compatible with a computing device 2800.

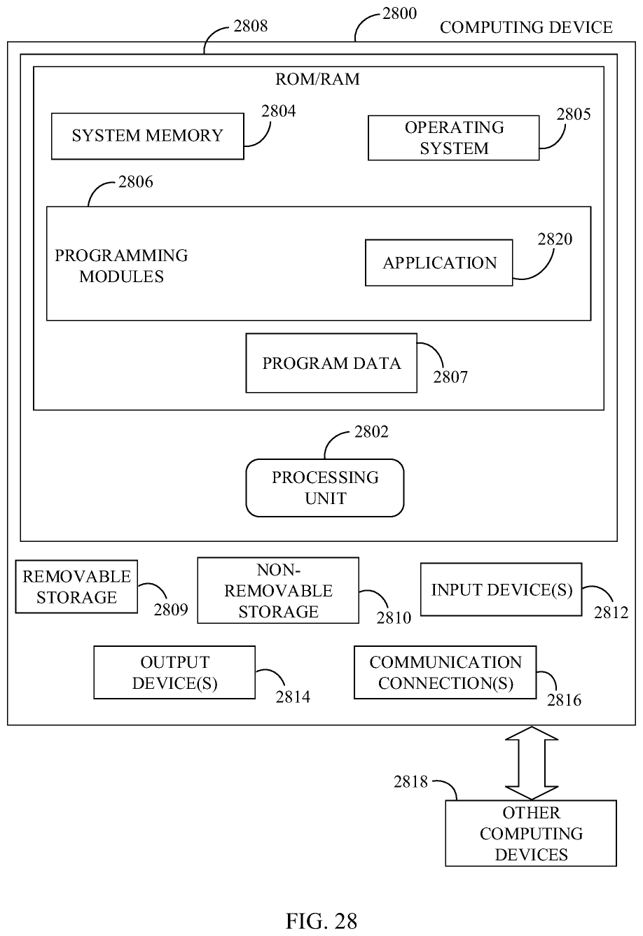

With reference to FIG. 28, a system consistent with an embodiment of the disclosure may include a computing device or cloud service, such as computing device 2800. In a basic configuration, computing device 2800 may include at least one processing unit 2802 and a system memory 2804. Depending on the configuration and type of computing device, system memory 2804 may comprise, but is not limited to, volatile (e.g., random-access memory (RAM)), non-volatile (e.g., read-only memory (ROM)), flash memory, or any combination. System memory 2804 may include operating system 2805, one or more programming modules 2806, and may include a program data 2807. Operating system 2805, for example, may be suitable for controlling computing device 2800's operation. In one embodiment, programming modules 2806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 28 by those components within a dashed line 2808.

Computing device 2800 may have additional features or functionality. For example, computing device 2800 may also include additional data storage devices (removable and/or non-removable) such as, for example, magnetic disks, optical disks, or tape. Such additional storage is illustrated in FIG. 28 by a removable storage 2809 and a non-removable storage 2810. Computer storage media may include volatile and non-volatile, removable and non-removable media implemented in any method or technology for storage of information, such as computer-readable instructions, data structures, program modules, or other data. System memory 2804, removable storage 2809, and non-removable storage 2810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2800. Any such computer storage media may be part of device 2800. Computing device 2800 may also have input device(s) 2812 such as a keyboard, a mouse, a pen, a sound input device, a touch input device, a location sensor, a camera, a biometric sensor, etc. Output device(s) 2814 such as a display, speakers, a printer, etc. may also be included. The aforementioned devices are examples and others may be used.

Computing device 2800 may also contain a communication connection 2816 that may allow device 2800 to communicate with other computing devices 2818, such as over a network in a distributed computing environment, for example, an intranet or the Internet. Communication connection 2816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2804, including operating system 2805. While executing on processing unit 2802, programming modules 2806 (e.g., application 2820 such as a media player) may perform processes including, for example, one or more stages of methods, algorithms, systems, applications, servers, databases as described above. The aforementioned process is an example, and processing unit 2802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

According to some aspects, a method of paying off debt through a lottery is disclosed. Further, the method comprises the steps: (A) providing a plurality of user account managed by at least one remote server (server, game server, etc.), wherein each user account is associated with a corresponding user personal computing (PC) device, and wherein each user account includes at least one debt profile, and wherein the debt profile includes a debtor information, a personal debt type, and a personal debt amount, (B) providing a plurality of virtual lotteries managed by the remote server, wherein each virtual lottery includes a lottery debt type and a lottery debt tier, (C) enabling each user account to navigate through the lottery debt type and the lottery debt tier of each virtual lottery with the corresponding user PC device, (D) prompting each user account to purchase at least one ticket for at least one desired lottery with the corresponding user PC device, wherein the desired lottery is from the plurality of virtual lotteries, (E) relaying the ticket for the desired lottery from the corresponding user PC device of at least one arbitrary user account to the remote server, if the ticket for the desired lottery is purchased by the arbitrary user account, wherein the arbitrary user account is any account from the plurality of user accounts, (F) randomly selecting a winner for each virtual lottery with the remote server, and (G) financially transferring a winning amount for the desired lottery to the debtor information of the arbitrary user account with the remote server, if the arbitrary user account is the winner of the desired lottery, and if the personal debt type of the arbitrary user account matches the lottery debt type of the desired lottery, and if the personal debt amount of the arbitrary user account is within or less than the lottery debt tier of the desired lottery.

Further, according to some aspects, the method of paying off debt through a lottery comprises providing at least one administrator account managed by the remote server, wherein the administrator account is associated with a corresponding administrator PC device, wherein a pot of each virtual lottery is managed by the remote server, retrieving a payout fraction for the virtual lotteries with the administrator PC device, and applying the payout fraction to the pot of the desired lottery with the remote server in order to divide the pot of the desired lottery into an applicable portion and a remainder portion.

Further, according to some aspects, the method of paying off debt through a lottery comprises designating the applicable portion of the desired lottery as the winning amount for the desired lottery with the remote server, if the applicable portion of the desired lottery is less than or within the lottery debt tier of the desired lottery tier.

Further, according to some aspects, the method of paying off debt through a lottery comprises the steps dividing the applicable portion of the desired lottery into a usable portion and a transferrable portion with the remote server, if the applicable portion of the desired lottery is greater than the lottery debt tier of the desired lottery tier, designating the usable portion of the desired lottery as the winning amount for the desired lottery with the remote server, comparing the lottery debt tier of each virtual lottery amongst each other with the remote server in order to identify at least one lower-tiered lottery from the plurality of virtual lotteries, wherein the lottery debt tier of the lower-tiered lottery is less than the lottery debt tier of the desired lottery, reallocating the transferrable portion of the desired lottery into the pot of the lower-tiered lottery with the remote server.

Further, according to some aspects, the method of paying off debt through a lottery comprises providing the at least one lower-tiered lottery as a plurality of lower-tiered lotteries, circumstantially assessing a reallocation percentage for each lower-tiered lottery with the remote server, and distributing the transferrable portion of the desired lottery into the pot of each lower-tiered lottery in accordance with the reallocation percentage with the remote server.

Further, according to some aspects, the method of paying off debt through a lottery comprises dividing the applicable portion of the desired lottery into a usable portion and a transferrable portion with the remote server, if the applicable portion of the desired lottery is greater than the lottery debt tier of the desired lottery tier, designating the usable portion of the desired lottery as the winning amount for the desired lottery with the remote server, managing at least one cash lottery with the remote server, reallocating the transferrable portion of the desired lottery into a pot of the cash lottery with the remote server.

Further, according to some aspects, the method of paying off debt through a lottery comprises financially transferring the remainder portion of the desired lottery to the administrator account with the remote server.

Further, according to some aspects, the method of paying off debt through a lottery comprises providing a plurality of purchased tickets managed by the remote server, wherein the plurality of purchased tickets includes the ticket for the desired lottery, cataloging each purchased ticket with the remote server by assigning a specific ticket number to each purchased ticket, and outputting the specific ticket number of the ticket of the desired lottery with the corresponding user PC device of the arbitrary user account.

Further, according to some aspects, the method of paying off debt through a lottery comprises providing at least one administrator account managed by the remote server, wherein the administrator account is associated with a corresponding administrator PC device, retrieving a debt owed amount from the debtor information of the arbitrary user account with the remote server, and financially transferring a full portion of the winning amount for the desired lottery to the debtor information of the arbitrary user account with the remote server during step (G), if the debt owed amount is greater than or equal to the winning amount for the desired lottery.

Further, according to some aspects, the method of paying off debt through a lottery comprises executing an electronic transfer for the full portion from the administrator account to the debtor information of the arbitrary user account with the remote server.

Further, according to some aspects, the method of paying off debt through a lottery comprises generating a payment note for the full portion with the remote server, wherein a payer of the payment note is the administrator account, and wherein a payee of the payment note is the debtor information of the arbitrary user account.

Further, according to some aspects, the method of paying off debt through a lottery comprises providing at least one administrator account managed by the remote server, wherein the administrator account is associated with a corresponding administrator PC device, retrieving a debt owed amount from the debtor information of the arbitrary user account with the remote server, financially transferring a partial portion of the winning amount for the desired lottery to the debtor information of the arbitrary user account with the remote server during step (G), if the debt owed amount is less than the winning amount for the desired lottery, wherein the partial portion is equal to the debt owed amount, and financially transferring a leftover portion of the winning amount for the desired lottery to the administrator account with the remote server during step (G), if the debt owed amount is less than the winning amount for the desired lottery, wherein the leftover portion is equal to a difference between the winning amount of the desired lottery and the partial portion.

Further, according to some aspects, the method of paying off debt through a lottery comprises executing an electronic transfer for the partial portion from the administrator account to the debtor information of the arbitrary user account with the remote server.

Further, according to some aspects, the method of paying off debt through a lottery comprises generating a payment note for the partial portion with the remote server, wherein a payer of the payment note is the administrator account, and wherein a payee of the payment note is the debtor information of the arbitrary user account.

Further, according to some aspects, the method of paying off debt through a lottery comprises providing the at least one debt profile as a plurality of debt profiles of a specific user account, wherein the specific user account is from the plurality of user accounts, prompting the specific user account to append a first debt profile into a second debt profile with the corresponding user PC device, wherein the first debt profile and the second debt profile are from the plurality of debt profiles, and compiling the first debt profile and the second debt profile into a single debt profile with the remote server, if the first debt profile is selected to be appended into the second debt profile by the specific user account, and if the personal debt type of the first debt profile matches the personal debt profile of the second debt profile.

Further, according to some aspects, the method of paying off debt through a lottery comprises providing each virtual lottery with a threshold for purchased tickets, tracking a current number for purchased tickets for each virtual lottery with the remote server, and randomly selecting a winner for at least one specific lottery with the remote server during step (F), if the current number of purchased tickets of the specific lottery is greater than or equal to the threshold for purchased tickets, wherein the specific lottery is from the plurality of virtual lotteries.

Further, according to some aspects, the method of paying off debt through a lottery comprises providing at least one third-party account, wherein the third-party account is associated with a corresponding third-party PC device, prompting the third-party account to enter a lottery search query for the arbitrary user account with the corresponding third-party PC device before step (D), relaying the lottery search query from the third-party PC device to the remote server, if the lottery search query is entered by the third-party account, comparing the lottery search query to each virtual lottery with the remote server in order to identify the desired lottery from the plurality of virtual lotteries, executing a financial purchase of the ticket for the desired lottery between the arbitrary user account and the third-party account through the remote server after step (D), relaying a purchase confirmation of the ticket from the third-party PC device to the user PC device, and outputting the purchase confirmation of the ticket with the user PC device.

According to some aspects, a method of paying off debt through a lottery game application is disclosed. Further, the method may include (A) The lottery game application is interfaced with a game server (server, remote server, etc.) and or a blockchain based game network which is used by a lottery gaming organization, and or a government agency in charge of lottery games, in providing a plurality of user account for the lottery players, wherein each user account communicates via a graphical user interface (GUI) (PC devices), and wherein each user account includes a debt profile, and wherein the debt profile includes a debtor information, a personal or corporate debt type, and a personal or corporate debt amount, (B) providing a plurality of virtual lotteries managed by the game server, wherein each virtual lottery includes a lottery debt type and a lottery debt tier, (C) enabling each user account to navigate through the lottery debt type and the lottery debt tier of each virtual lottery via a graphical user interface (GUI) and allowing each user account to make payment via payment systems integrated to the lottery game application, (D) prompting each user account to purchase one or multiple tickets for any of the desired debt type lottery via the user's GUI, wherein the desired lottery is from the plurality of virtual lotteries, (E) the game server automatically sends the ticket number(s) and debt profile of each user account to the appropriate debt type and debt tier, (F) the game server simultaneously distributes a portion of the funds to cash tiers for cash prizes within each debt type and debt tier; as well as distribute a portion of the funds to designated administrator's account for each debt type, (G) the lottery game application randomly selecting from each debt type and debt tier after reaching a threshold of number of tickets purchased by the players for each lottery debt type and debt tier, (H) the lottery game application randomly selecting from the pool of user accounts for cash prizes from cash tiers for each debt type and debt tier, (I) financially transferring a winning amount for the desired lottery to the debtor information of the arbitrary user account with the game server, if the arbitrary user account is the winner of the desired lottery, and if the personal debt type of the arbitrary user account matches the lottery debt type of the desired lottery, and if the personal debt amount of the arbitrary user account is within or less than the lottery debt tier of the desired lottery.

Further, according to some embodiments, the method of paying off debt through a lottery game application may include the game server creates an administrator account for each debt type which manages all funds and tickets purchased in a particular debt type. It further redistributes the debt type into debt tiers and divides the funds from ticket sales into applicable portion and a remainder portion.

Further, according to some embodiments, the method of paying off debt through a lottery game application may include designating the applicable portion of the desired lottery as the winning amount if it is less than or within the lottery debt tier of the desired debt type.

Further, according to some embodiments, the method of paying off debt through a lottery game application may include dividing the applicable portion of the desired lottery into a usable portion and a transferrable portion with the server, if the applicable portion of the desired lottery is greater than the lottery debt tier of the desired debt type, designating the usable portion of the desired debt type as the winning amount for the desired lottery with the game server, and using the game server to compare the lottery debt tier and reallocating the transferrable portion of the desired lottery into the pot of the lower-tiered lottery.

Further, according to some embodiments, the method of paying off debt through a lottery game application may include circumstantially assessing a reallocation percentage for each lower-tiered lottery with the game server, distributing the transferrable portion of the desired lottery into the pot of each lower-tiered lottery in accordance with the reallocation percentage with the game server.

Further, according to some embodiments, the method of paying off debt through a lottery game application may include dividing the applicable portion of the desired lottery into a usable portion and a transferrable portion with the game server, if the applicable portion of the desired lottery is greater than the lottery debt tier of the desired debt type, designating the usable portion of the desired lottery as the winning amount for the desired lottery with the game server, and managing the cash lottery account with the game server by reallocating a percentage of the transferrable portion of the desired lottery into the pot of the cash lottery.

Further, according to some embodiments, the method of paying off debt through a lottery game application may include using the game server to transfer the remainder portion of the desired lottery funds to the administrator account.

Further, according to some embodiments, the method of paying off debt through a lottery game application may include providing a plurality of purchased tickets managed by the game server, wherein the plurality of purchased tickets includes the ticket for the desired lottery debt type, cataloging each purchased ticket with the server by assigning a specific ticket number to each purchased ticket, and outputting the desired lottery debt type name, ticket number, draw date, purchase date and time to the corresponding GUI of the arbitrary user account. Each ticket is linked to the user account debt profile, making it impossible for anyone else to claim the winning ticket.

Further, according to some embodiments, the method of paying off debt through a lottery game application may include providing an administrator account for each lottery debt type managed by the game server, wherein the administrator account is integrated to an application server (the server, remote server, etc.) used by a lottery gaming organization and or a government agency in charge of lottery, retrieving a debt owed amount from the debtor information of the arbitrary user account with the game server, and financially transferring a full or partial portion of the winning amount for the desired lottery to the debtor information of the arbitrary user account with the application server during step (I).

Further, according to some embodiments, the method of paying off debt through a lottery game application may include providing a debt profile as a plurality of debt profiles of a specific user account, wherein the specific user account is from the plurality of user accounts, prompting the specific user account to append a first debt profile into a second debt profile with the corresponding user GUI, wherein the first debt profile and the second debt profile are from the plurality of debt profiles, and compiling the first debt profile and the second debt profile into a single debt profile with the game server, if the first debt profile is selected to be appended into the second debt profile of the specific user account, and if the debt type of the first debt profile matches the debt profile of the second debt type.

Although the present disclosure has been explained in relation to its preferred embodiment, it is to be understood that many other possible modifications and variations can be made without departing from the spirit and scope of the disclosure.

What is claimed is:

1. A device for facilitating users to play lotteries for paying off debts of the users, the device comprising:
at least one input device configured for:
receiving a plurality of requests from a plurality of users;
receiving an indication for purchasing a number of tickets of at least one of a plurality of virtual lotteries from each of the plurality of users; and
receiving user data associated with each of the plurality of users from each of the plurality of users, wherein the user data comprises a user information and a debt profile of each of the plurality of users, wherein the debt profile comprises a debtor information of a debtor of each of the plurality of users and a personal debt type and a personal debt amount of a debt of each of the plurality of users;
a storage device communicatively coupled with the at least one input device, wherein the storage device is configured for:
retrieving at least one of a plurality of tickets available to each of the plurality of users for the plurality of virtual lotteries based on each of the plurality of requests, wherein each virtual lottery of the plurality of virtual lotteries comprises a lottery debt type and a lottery debt tier, wherein each virtual lottery of the plurality of virtual lotteries is provided with a threshold of purchased tickets, wherein the plurality of tickets comprises a plurality of ticket identifiers, wherein the plurality of ticket identifiers are unique; and
storing a number of ticket identifiers of the number of tickets of at least one of the plurality of virtual lotteries and the user data of each of the plurality of users assigned to the number of tickets of at least one of the plurality of virtual lotteries based on the assigning;
at least one output device communicatively coupled with the storage device, wherein the at least one output device is configured for displaying at least one of the plurality of tickets available to each of the plurality of users for the plurality of virtual lotteries to each of the plurality of users; and
a processing device communicatively coupled with the storage device, wherein the processing device is configured for:
processing a transaction for purchasing the number of tickets of at least one of the plurality of virtual lotteries by each of the plurality of users based on the indication and the user information;
assigning the number of tickets of at least one of the plurality of virtual lotteries to each of the plurality of users based on the processing of the transaction;
tracking a current number of purchased tickets of each virtual lottery of the plurality of virtual lotteries based on the transaction;
comparing the current number of purchased tickets with the threshold of purchased tickets for each virtual lottery of the plurality of virtual lotteries;
randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries;
identifying a winner from the plurality of users using a ticket identifier of the winning ticket based on the randomly selecting of the winning ticket, wherein the winner is assigned to the winning ticket;
comparing the personal debt type of the winner with the lottery debt type of the virtual lottery and the personal debt amount of the winner with the lottery debt tier of the virtual lottery based on the identifying; and
financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

2. The device of claim 1, wherein the storing of the number of ticket identifiers of the number of tickets of at least one of the plurality of virtual lotteries and the user data of each of the plurality of users assigned to the number of tickets of at least one of the plurality of virtual lotteries comprises storing the number of ticket identifiers of the number of tickets of at least one of the plurality of virtual lotteries and the user data of each of the plurality of users assigned to the number of tickets of at least one of the plurality of virtual lotteries in a distributed ledger based on the assigning.

3. The device of claim 1, wherein the retrieving of at least one of the plurality of tickets available to each of the plurality of users for the plurality of virtual lotteries comprises retrieving at least one of the plurality of tickets available to each of the plurality of users for the plurality of virtual lotteries from a distributed ledger based on each of the plurality of requests.

4. The device of claim 1, wherein the financially transferring of the winning amount further comprises generating a check of the winning amount for the debtor using the debtor information and the user information, wherein the processing device is communicatively coupled with a check printer comprised in the device, wherein the check printer is configured for printing a physical check for the debtor.

5. The device of claim 1 further comprising a ticket printer communicatively coupled with the processing device, wherein the ticket printer is configured for printing a number of physical tickets for the number of tickets based on the processing of the transaction, wherein the number of physical tickets comprises a number of representations of the number of ticket identifiers.

6. The device of claim 5 further comprising at least one scanning device communicatively coupled with the processing device, wherein the at least one scanning device is configured for detecting a ticket identifier of a physical ticket based on scanning a representation of the ticket identifier, wherein the processing device is further configured for:
comparing the ticket identifier of the physical ticket with the ticket identifier of the winning ticket; and
determining the physical ticket as the winning ticket based on the comparing of the ticket identifier of the physical ticket with the ticket identifier of the winning ticket, wherein the financially transferring of the winning amount of the virtual lottery to the debtor of the winner is further based on the determining.

7. The device of claim 1, wherein the debtor information comprises a mode of payment of the debt, wherein the financially transferring of the winning amount further comprises financially transferring the winning amount to the debtor through the mode of payment.

8. The device of claim 1, wherein the processing device is further configured for generating a number of cryptocurrency tokens for the winning amount, wherein the generating of the number of cryptocurrency tokens comprises minting the number of cryptocurrency tokens for the winning amount, wherein the financially transferring of the winning amount further comprises transferring the number of cryptocurrency tokens to the debtor.

9. The device of claim 1, wherein the randomly selecting of the winning ticket from the number of tickets for the virtual lottery of the plurality of virtual lotteries comprises randomly selecting the winning ticket for the virtual lottery of the plurality of virtual lotteries using at least one random ticket selection model based on the comparing of the current number of purchased tickets with the threshold of purchased tickets for each virtual lottery of the plurality of virtual lotteries.

10. The device of claim 1, wherein the processing device is further configured for:
analyzing the current number of tickets;
determining a rate of purchasing of tickets of each virtual lottery of the plurality of virtual lotteries based on the analyzing of the current number of tickets; and
determining the threshold of purchased tickets for each virtual lottery of the plurality of virtual lotteries based on the determining of the rate of purchasing of tickets of each virtual lottery of the plurality of virtual lotteries.

11. The device of claim 1 further comprising a communication device communicatively coupled with the processing device, wherein the communication device is configured for receiving the threshold of purchased tickets for each virtual lottery of the plurality of virtual lotteries from at least one user device.

12. The device of claim 1, wherein each virtual lottery of the plurality of virtual lotteries is provided with the threshold of purchased tickets corresponding to at least one of the lottery debt type and the lottery debt tier, wherein the processing device is further configured for categorizing the current number of purchased tickets of each virtual lottery of the plurality of virtual lotteries current into at least one of the lottery debt type and the lottery debt tier, wherein the comparing of the current number of purchased tickets with the threshold of purchased tickets for each virtual lottery of the plurality of virtual lotteries comprises comparing the current number of purchased tickets with the threshold of purchased tickets corresponding to at least one of the lottery debt type and the lottery debt tier for each virtual lottery of the plurality of virtual lotteries based on the categorizing, wherein the randomly selecting of the winning ticket from the number of tickets for the virtual lottery of the plurality of virtual lotteries comprises randomly selecting the winning ticket from the number of tickets for at least one of the lottery debt type and the lottery debt tier of the virtual lottery of the plurality of virtual lotteries.

13. A device for facilitating users to play lotteries for paying off debts of the users, the device comprising:
at least one input device configured for:
receiving a plurality of requests from a plurality of users;
receiving an indication for purchasing a number of tickets of at least one of a plurality of virtual lotteries from each of the plurality of users; and
receiving user data associated with each of the plurality of users from each of the plurality of users, wherein the user data comprises a user information and a debt profile of each of the plurality of users, wherein the debt profile comprises a debtor information of a debtor of each of the plurality of users and a personal debt type and a personal debt amount of a debt of each of the plurality of users;
a storage device communicatively coupled with the at least one input device, wherein the storage device is configured for:
retrieving at least one of a plurality of tickets available to each of the plurality of users for the plurality of virtual lotteries from a distributed ledger based on each of the plurality of requests, wherein each virtual lottery of the plurality of virtual lotteries comprises a lottery debt type and a lottery debt tier, wherein each virtual lottery of the plurality of virtual lotteries is provided with a threshold of purchased tickets, wherein the plurality of tickets comprises a plurality of ticket identifiers, wherein the plurality of ticket identifiers are unique; and
storing a number of ticket identifiers of the number of tickets of at least one of the plurality of virtual lotteries and the user data of each of the plurality of users assigned to the number of tickets of at least one of the plurality of virtual lotteries in the distributed ledger based on the assigning;
at least one output device communicatively coupled with the storage device, wherein the at least one output device is configured for displaying at least one of the plurality of tickets available to each of the plurality of users for the plurality of virtual lotteries to each of the plurality of users; and
a processing device communicatively coupled with the storage device, wherein the processing device is configured for:
processing a transaction for purchasing the number of tickets of at least one of the plurality of virtual lotteries by each of the plurality of users based on the indication and the user information;
assigning the number of tickets of at least one of the plurality of virtual lotteries to each of the plurality of users based on the processing of the transaction;
tracking a current number of purchased tickets of each virtual lottery of the plurality of virtual lotteries based on the transaction;
comparing the current number of purchased tickets with the threshold of purchased tickets for each virtual lottery of the plurality of virtual lotteries;
randomly selecting a winning ticket from the number of tickets for a virtual lottery of the plurality of virtual lotteries based on the comparing of the current number of purchased tickets with the threshold of purchased tickets for each virtual lottery of the plurality of virtual lotteries;
identifying a winner from the plurality of users using a ticket identifier of the winning ticket based on the randomly selecting of the winning ticket, wherein the winner is assigned to the winning ticket;
comparing the personal debt type of the winner with the lottery debt type of the virtual lottery and the personal debt amount of the winner with the lottery debt tier of the virtual lottery based on the identifying; and
financially transferring a winning amount of the virtual lottery to the debtor of the winner using the debtor information based on the comparing of the personal debt type of the winner with the lottery debt type of the virtual lottery and the personal debt amount of the winner with the lottery debt tier of the virtual lottery.

14. The device of claim 13, wherein the financially transferring of the winning amount further comprises generating a check of the winning amount for the debtor using the debtor information and the user information, wherein the processing device is communicatively coupled with a check printer comprised in the device, wherein the check printer is configured for printing a physical check for the debtor.

15. The device of claim 13 further comprising a ticket printer communicatively coupled with the processing device, wherein the ticket printer is configured for printing a number of physical tickets for the number of tickets based on the processing of the transaction, wherein the number of physical tickets comprises a number of representations of the number of ticket identifiers.

16. The device of claim 15 further comprising at least one scanning device communicatively coupled with the processing device, wherein the at least one scanning device is configured for detecting a ticket identifier of a physical ticket based on scanning a representation of the ticket identifier, wherein the processing device is further configured for:
comparing the ticket identifier of the physical ticket with the ticket identifier of the winning ticket; and
determining the physical ticket as the winning ticket based on the comparing of the ticket identifier of the physical ticket with the ticket identifier of the winning ticket, wherein the financially transferring of the winning amount of the virtual lottery to the debtor of the winner is further based on the determining.

17. The device of claim 13, wherein the debtor information comprises a mode of payment of the debt, wherein the financially transferring of the winning amount further comprises financially transferring the winning amount to the debtor through the mode of payment.

18. The device of claim 13, wherein the processing device is further configured for generating a number of cryptocurrency tokens for the winning amount, wherein the generating of the number of cryptocurrency tokens comprises minting the number of cryptocurrency tokens for the winning amount, wherein the financially transferring of the winning amount further comprises transferring the number of cryptocurrency tokens to the debtor.

19. The device of claim 13, wherein the randomly selecting of the winning ticket from the number of tickets for the virtual lottery of the plurality of virtual lotteries comprises randomly selecting the winning ticket for the virtual lottery of the plurality of virtual lotteries using at least one random ticket selection model based on the comparing of the current number of purchased tickets with the threshold of purchased tickets for each virtual lottery of the plurality of virtual lotteries.

20. The device of claim 13, wherein the processing device is further configured for:
analyzing the current number of tickets;
determining a rate of purchasing of tickets of each virtual lottery of the plurality of virtual lotteries based on the analyzing of the current number of tickets; and
determining the threshold of purchased tickets for each virtual lottery of the plurality of virtual lotteries based on the determining of the rate of purchasing of tickets of each virtual lottery of the plurality of virtual lotteries.
